(19) United States
(12) Patent Application Publication
(10) Pub. No.: US 2025/0384515 A1
(43) Pub. Date: Dec. 18, 2025

(54) SERVER APPARATUS AND VEHICLE

(71) Applicant: SUBARU CORPORATION, Tokyo (JP)

(72) Inventors: Tomoyuki KITAMURA, Tokyo (JP); Keita NAKAHASHI, Tokyo (JP); Shunichi NAKAMURA, Tokyo (JP); Takumi TAKADA, Tokyo (JP); Hiroaki KUDO, Tokyo (JP); Yosuke KANEKO, Tokyo (JP)

(21) Appl. No.: 19/228,868

(22) Filed: Jun. 5, 2025

(30) Foreign Application Priority Data
Jun. 17, 2024 (JP) 2024-097256

(51) Int. Cl. G06Q 50/40; B60L 58/12; B60L 58/18; G01C 21/34; G07C 5/00

(52) U.S. Cl. CPC G06Q 50/40; B60L 58/12; B60L 58/18; G01C 21/3438; G07C 5/008

(57) ABSTRACT

A server apparatus includes one or more processors and a storage medium storing a program. The program includes one or more instructions that cause the one or more processors to: receive problem information from a disabled vehicle having an insufficient remaining battery charge; extract candidate rescue vehicles each including a first battery and a second battery; select, as a joint rescue candidate group, two or more of the candidate rescue vehicles to jointly rescue the disabled vehicle; determine a secured remaining charge to be secured by the second battery of each of the candidate rescue vehicles in the joint rescue candidate group; and notify each of the candidate rescue vehicles in the joint rescue candidate group of the secured remaining charge to charge the second battery from the first battery such that the second battery has a remaining charge greater than or equal to the secured remaining charge.

### CROSS-REFERENCE TO RELATED APPLICATIONS

The present application claims priority from Japanese Patent Application No. 2024-097256 filed on Jun. 17, 2024, the entire contents of which are hereby incorporated by reference.

### BACKGROUND

The disclosure relates to a technical field of a server apparatus and a vehicle that perform a process for charging a traveling battery used for traveling.

Electric vehicles that can travel without using fuel such as gasoline and hybrid vehicles that can travel using both fuel and electricity as energy sources are becoming popular.

An electric vehicle is affected when a traveling battery used for traveling runs out of charge, and a driver of the electric vehicle always pays attention to the remaining charge of the traveling battery while driving.

Accordingly, Japanese Unexamined Patent Application Publication (JP-A) No. 2012-120416 discloses a technique for exchanging a low-power auxiliary battery of a vehicle with an auxiliary battery of another vehicle.

### SUMMARY

An aspect of the disclosure provides a server apparatus including one or more processors and a storage medium storing a program configured to be executed by the one or more processors. The program includes one or more instructions. The one or more instructions are configured to cause the one or more processors to receive problem information from a disabled vehicle having an insufficient remaining battery charge. The problem information includes position information of the disabled vehicle and charge insufficiency information of a battery of the disabled vehicle. The one or more instructions are configured to cause the one or more processors to extract a plurality of candidate rescue vehicles that are vehicles other than the disabled vehicle. Each of the candidate rescue vehicles is configured to rescue the disabled vehicle and includes a first battery and a second battery. The one or more instructions are configured to cause the one or more processors to select, as a joint rescue candidate group, two or more candidate rescue vehicles from among the candidate rescue vehicles to jointly rescue the disabled vehicle. The one or more instructions are configured to cause the one or more processors to e determine, based on the charge insufficiency information, a secured remaining charge that is a remaining charge to be secured by the second battery of each of the two or more candidate rescue vehicles in the joint rescue candidate group. The one or more instructions are configured to cause the one or more processors to notify each of the two or more candidate rescue vehicles in the joint rescue candidate group of the secured remaining charge to charge the second battery from the first battery such that the second battery has a remaining charge greater than or equal to the secured remaining charge.

An aspect of the disclosure provides a vehicle including a traveling battery charged with electric power for the vehicle to travel, one or more processors, and a storage medium storing a program configured to be executed by the one or more processors. The traveling battery includes a first battery and a second battery. The program includes one or more instructions. The one or more instructions are configured to cause the one or more processors to receive rescue request information that is information on a request for rescuing a disabled vehicle having an insufficient remaining battery charge. The rescue request information includes information on a meeting point at which the vehicle meets the disabled vehicle and information on a secured remaining charge. The secured remaining charge is an amount of electric power to be secured by the vehicle to compensate for the insufficient remaining battery charge of the disabled vehicle in cooperation with another vehicle. The one or more instructions are configured to cause the one or more processors to charge the second battery from the first battery such that the second battery has a remaining charge greater than or equal to the secured remaining charge by a time when the vehicle reaches the meeting point.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a diagram illustrating an example configuration of a rescue system according to an embodiment;

FIG. 2 is a block diagram illustrating an example hardware configuration of a server apparatus;

FIG. 3 is a block diagram illustrating an example hardware configuration of a vehicle;

FIG. 4 is a block diagram illustrating a functional configuration of the server apparatus;

FIG. 5 is a block diagram illustrating a functional configuration of the vehicle;

FIG. 6 is a diagram illustrating an example of a general flow of processing performed by the server apparatus and the vehicle, together with FIG. 7;

FIG. 7 is a diagram illustrating the flow of the processing, continuing from FIG. 6;

FIG. 8 is a flowchart illustrating an example of a process executed by a CPU of the server apparatus;

FIG. 9 is a flowchart illustrating an example of a rescue vehicle determination process executed by the CPU of the server apparatus;

FIG. 10 is a flowchart illustrating an example of a post-rescue process executed by the CPU of the server apparatus;

FIG. 11 is a flowchart illustrating an example of a battery return process executed by the CPU of the server apparatus;

FIG. 12 is a flowchart illustrating a modification of the rescue vehicle determination process executed by the CPU of the server apparatus;

FIG. 13 is a flowchart illustrating an example of a process executed by a control device of the vehicle, together with FIG. 14;

FIG. 14 is a flowchart illustrating the example of the process executed by the control device of the vehicle, together with FIG. 13;

FIG. 15 is a flowchart illustrating an example of a charging process during travel, which is executed by the control device of the vehicle;

FIG. 16 is a diagram illustrating an example configuration of a rescue system according to an embodiment;

FIG. 17 is a diagram schematically illustrating routes along which a disabled vehicle and rescue vehicles travel and meeting points according to the embodiment;

FIG. 18 is a flowchart illustrating an example of a rescue vehicle determination process executed by the CPU of the server apparatus according to the embodiment;

FIG. 19 is a diagram schematically illustrating routes along which a disabled vehicle and rescue vehicles travel and a meeting point according to a first modification;

FIG. 20 is a block diagram illustrating an example hardware configuration of a vehicle according to the first modification;

FIG. 21 is a diagram illustrating an example of the exchange of second batteries between the disabled vehicle and the rescue vehicles according to the first modification;

FIG. 22 is a diagram illustrating an example of the exchange of second batteries between a disabled vehicle and rescue vehicles according to a second modification; and

FIG. 23 is a diagram illustrating an example of the transfer of second batteries through exchange and the remaining charge of the second batteries before and after the exchange according to the second modification.

### DETAILED DESCRIPTION

In JP-A No. 2012-120416, a vehicle capable of rescue operations is limited to a vehicle for which a reserve mode is on, and efficient rescue is not necessarily performed.

It is desirable to efficiently rescue a disabled vehicle that has encountered a problem related to running out of electricity.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. Configuration of Rescue System

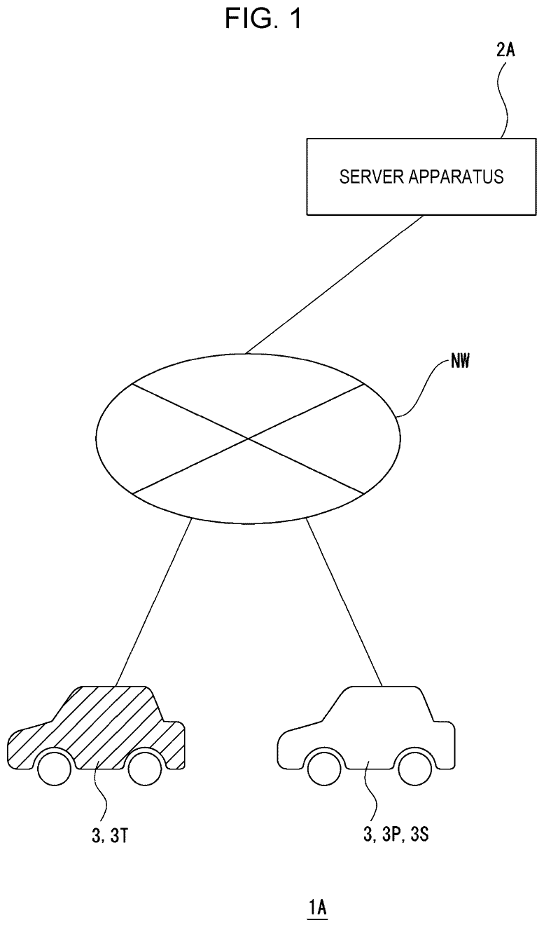

FIG. 1 illustrates an example configuration of a rescue system 1A according to a first embodiment.

The rescue system 1A is a system for rescuing a vehicle from a problematic situation, and includes a server apparatus 2A and vehicles 3. The server apparatus 2A includes one or more computer devices.

The server apparatus 2A and the vehicles 3 are configured to communicate with each other via a communication network NW mainly based on wireless communication. A part of the communication network NW may include a wired communication network.

The server apparatus 2A is a computer device including a central processing unit (CPU), a read only memory (ROM), a random access memory (RAN), and so on. The server apparatus 2A executes a program stored in the ROM or a program loaded from a storage to the RAM to implement a predetermined function.

The server apparatus 2A of the rescue system 1A has functions such as a function of accepting rescue of a vehicle 3 that has encountered a problem among the vehicles 3, and a function of transmitting a request for addressing the problem to another vehicle 3.

The vehicles 3 are various vehicles such as electric vehicles and hybrid vehicles that use electric power as at least part of energy for driving.

The vehicles 3 may encounter various kinds of problems. The present embodiment describes rescue of a vehicle 3 with a problem of running out of electricity.

Among the vehicles 3, a vehicle 3 that has run out of electricity or a vehicle 3 that will run out of electricity if access to a charging station is unavailable is referred to as a “disabled vehicle 3T”. In FIG. 1 and the other drawings, the disabled vehicle 3T among the vehicles 3 is indicated by hatching.

Among the vehicles 3, furthermore, vehicles 3 extracted to rescue the disabled vehicle 3T are referred to as “candidate rescue vehicles 3P”. Among the candidate rescue vehicles 3P, a vehicle 3 that actually rescues the disabled vehicle 3T is referred to as a “rescue vehicle 3S”.

The disabled vehicle 3T, the candidate rescue vehicles 3P, and the rescue vehicle 3S are simply referred to individually as a “vehicle 3” or collectively as the “vehicles 3” unless distinguished from one another.

### 2. Various Configurations

### 2-1. Hardware Configuration of Server Apparatus

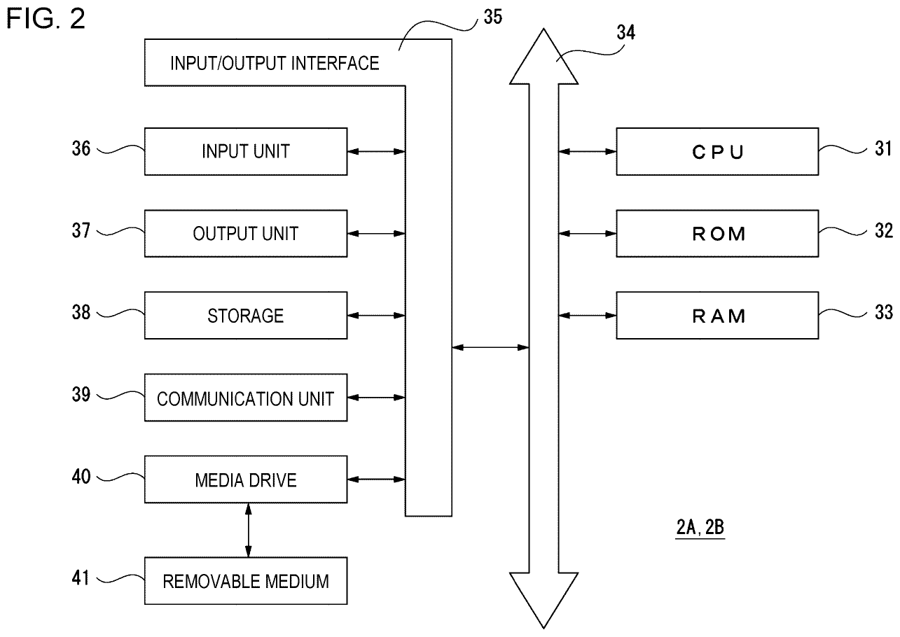

FIG. 2 illustrates an example hardware configuration of the server apparatus 2A.

The server apparatus 2A includes a CPU 31, a ROM 32, a RAM 33, a bus 34, an input/output interface 35, an input unit 36, an output unit 37, a storage 38, a communication unit 39, a media drive 40, and so on.

The CPU 31 executes various processes in accordance with a program stored in the ROM 32 or a program loaded from the storage 38 to the RAM 33. The RAM 33 also stores information necessary for the CPU 31 to execute various processes.

The CPU 31, the ROM 32, and the RAM 33 are coupled to each other via the bus 34. The input/output interface 35 is also coupled to the bus 34.

The input unit 36, the output unit 37, the storage 38, the communication unit 39, and the media drive 40 are coupled to the input/output interface 35.

The input unit 36 includes a keyboard, a mouse, a touch panel, a microphone, and the like.

The output unit 37 includes a display such as a liquid crystal display (LCD) or an organic electroluminescent (EL) panel, a speaker, and the like.

The storage 38 includes a hard disk drive (HDD), a flash memory device, and the like. The storage 38 stores information on the vehicles 3 registered in the system.

The storage 38 may be an external database device. That is, the information on the vehicles 3 registered in the system may be stored in the storage 38 included in the server apparatus 2A, or may be stored in a database device serving as an information processing device provided outside the server apparatus 2A.

In the following description, the expression “storing information in the storage 38” is used to include storing information in a database device provided outside the server apparatus 2A.

The communication unit 39 performs communication processing and inter-device communication via a communication network.

A removable medium 41, such as a magnetic disk, an optical disk, or a magneto-optical disk, or a semiconductor memory as necessary, is placed on the media drive 40, and information is written to or read from the removable medium 41.

In the server apparatus 2A, data or a program is uploaded or downloaded through communication by the communication unit 39. Further, data or a program can be transferred via the removable medium 41.

When the CPU 31 performs processing operations based on various programs, information processing and communication necessary for the server apparatus 2A are executed.

### 2-2. Hardware Configuration of Vehicle

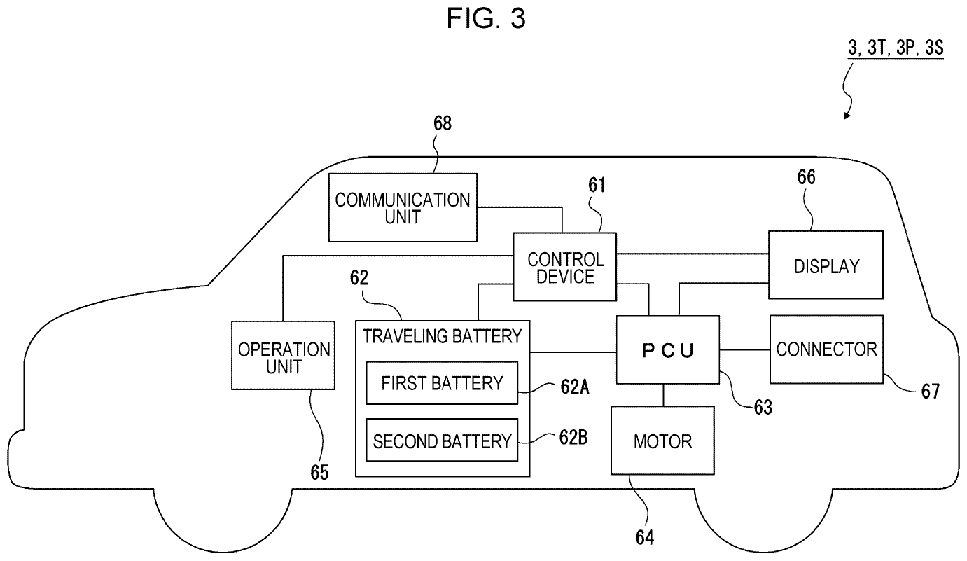

FIG. 3 illustrates an example hardware configuration of a vehicle 3.

The vehicle 3 includes a control device 61, a traveling battery 62, a power control unit (PCU) 63, a motor 64, an operation unit 65, a display 66, a connector 67, and a communication unit 68.

FIG. 3 illustrates only some of the components of the vehicle 3, and the vehicle 3 may appropriately include a map locator, various sensors for driving, a communication device, and the like, which are not illustrated.

The control device 61 includes a processor such as a CPU, a memory, and so on, and performs overall control of the vehicle 3. The control device 61 may be provided as a single unit or may include electronic control units (ECUs). The ECUs may include various kinds of ECUs such as a battery control ECU that performs charging control of the traveling battery 62, a display control ECU that performs display control of a display device (including a meter or the like) included in the vehicle 3, an airbag control ECU, an air conditioning control ECU, and a communication ECU that performs various kinds of communication.

The control device 61 executes various programs stored in the memory or the like to implement various functions.

The functions of the control device 61 will be described below.

The traveling battery 62 is a high-voltage battery used for travel of the vehicle 3. The traveling battery 62 supplies electric power used for driving wheels of the vehicle 3, electric power used for operating an air conditioner of the vehicle 3, and electric power used for operating other devices of the vehicle 3. In FIG. 3, the supply of electric power used for driving the wheels of the vehicle 3 from the traveling battery 62 and the supply of electric power to the display 66 from the traveling battery 62 are illustrated, and the supply of electric power used for the operations of the other components is not illustrated.

The traveling battery 62 is charged based on a direct-current (DC) voltage supplied from the PCU 63.

The traveling battery 62 supplies a power supply voltage to the PCU 63 to drive the motor 64.

The traveling battery 62 includes a first battery 62A and a second battery 62B that are physically separate from each other. The first battery 62A and the second battery 62B are both replaceable batteries. However, the first battery 62A and the second battery 62B are different in replacement timing and operation mode.

The first battery 62A is a battery to be replaced with a new one when subjected to, for example, failure, performance deterioration, or the like. That is, the first battery 62A is a battery that is left installed in the same vehicle 3 unless special circumstances occur and is not frequently replaced.

In contrast, the second battery 62B is a battery to be replaced with a battery with high remaining charge when the remaining charge is low or exhausted. That is, the second battery 62B is a battery that can be usually replaced.

Replacing the second battery 62B with a battery with high remaining charge can extend the cruising distance of the vehicle 3.

The second battery 62B may be replaced when the vehicle 3 stops at a service station where a spare second battery 62B is prepared, or may be exchanged with the second battery 62B of another vehicle 3 for which a long cruising distance is not required.

The first battery 62A can supply electric power to the second battery 62B to increase the remaining charge of the second battery 62B.

The PCU 63 includes an inverter, a direct current to direct current (DC-DC) converter, and so on to drive the motor 64.

The PCU 63 generates, based on the supplied power supply voltage, an alternating-current (AC) current for driving the motor 64 and supplies the AC current to the motor 64. The PCU 63 controls the AC current to perform torque control of the motor 64. The PCU 63 may have a regenerative braking function to optimize energy efficiency using regenerative energy.

The PCU 63 performs charging control for charging the second battery 62B using the remaining charge of the first battery 62A as necessary. When the vehicle 3 is traveling in a normal situation where the vehicle 3 is not engaged in the rescue of another vehicle 3, the PCU 63 drive the vehicle 3 to travel using the remaining charge of the second battery 62B.

When the second battery 62B is charged from the first battery 62A, the PCU 63 can perform rapid charging control of the second battery 62B at the sacrifice of driving performance such as acceleration force.

The motor 64 is configured as a motor generator having an electric power generation function. The motor 64 drives the wheels based on the supplied AC current.

The operation unit 65 includes, for example, operating elements such as various buttons and levers arranged in front of a driver's seat of the vehicle 3. The operation unit 65 may also include a multi-function display (MFD) having a touch panel function, a display of a navigation system, and so on.

The user of the disabled vehicle 3T can operate the operation unit 65 to notify the server apparatus 2A that the user's vehicle is the disabled vehicle 3T or that the user makes a rescue request to address the problem encountered by the user.

The user of a candidate rescue vehicle 3P selected as a vehicle 3 for addressing the problem can operate the operation unit 65 to notify the server apparatus 2A of whether the user accepts the rescue request.

The display 66 is a generic representation of, for example, an MFD installed in front of the driver and other display devices for presenting information to the driver.

The display 66 performs display based on detection signals detected by the various sensors included in the vehicle 3.

The display 66 appropriately displays various kinds of information such as the total travel distance of the vehicle 3, the outside air temperature, and the instantaneous power consumption.

The display 66 can also display map information, extracted route information, and so on.

In the disabled vehicle 3T, the display 66 displays, for example, a menu for making a rescue request, and information on the rescue vehicle 3S provided from the server apparatus 2A.

In the rescue vehicle 3S, the display 66 may display the current position of the disabled vehicle 3T, a meeting point to meet the disabled vehicle 3T, and so on.

The connector 67 has a structure such that a charging plug included in a charging facility installed at home or in a charging station can be inserted into the connector 67. The connector 67 outputs an AC voltage supplied through the inserted charging plug to the PCU 63. The PCU 63 includes an AC/DC converter to obtain a DC voltage, and supplies the DC voltage to the traveling battery 62 to charge the traveling battery 62.

The communication unit 68 communicates with an external information processing device under the control of the control device 61. Communication through the communication unit 68 allows transmission of information on the vehicle 3 to the server apparatus 2A and reception of various kinds of information from the server apparatus 2A.

### 2-3. Functional Configuration of Server Apparatus

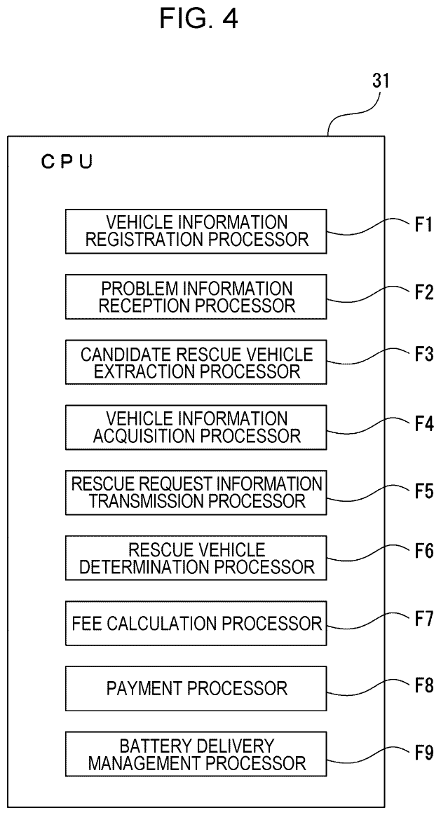

FIG. 4 illustrates an example functional configuration of the server apparatus 2A.

The CPU 31 of the server apparatus 2A executes a program to serve as a vehicle information registration processor F1, a problem information reception processor F2, a candidate rescue vehicle extraction processor F3, a vehicle information acquisition processor F4, a rescue request information transmission processor F5, a rescue vehicle determination processor F6, a fee calculation processor F7, a payment processor F8, and a battery delivery management processor F9.

The vehicle information registration processor F1 performs a process for storing information on the vehicle 3 input by a user who receives a service provided by the server apparatus 2A in the storage 38 or the database device.

The vehicle information registration processor F1 stores various kinds of information in the storage 38 as the information on the vehicle 3. Examples of such information include a manufacturer and a vehicle type of the vehicle 3, a driving method of the vehicle 3, a manufacturer, configuration, and owner information of the traveling battery 62, electric efficiency information, a travel distance, and problem history information.

The information stored by the vehicle information registration processor F1 may include not only the information on the vehicle 3 but also information on a user who owns the vehicle 3.

For example, the vehicle information registration processor F1 may store, in the storage 38, as the information on the user of the vehicle 3, information such as a user name, an ID (Identification), a password, a purchase history of the vehicle 3, and a rescue history.

The owner information of the traveling battery 62 is information stored considering a case where the owner of the traveling battery 62 is different from the owner of the vehicle 3.

In the present embodiment, the traveling battery 62 mounted on the disabled vehicle 3T is exchanged with the traveling battery 62 of the rescue vehicle 3S as appropriate. Therefore, the traveling battery 62 mounted on the vehicle 3 does not necessarily coincide with the owner of the vehicle 3.

The traveling battery 62 installed in the vehicle 3 may be a battery lent to the user of the vehicle 3 by a company that provides the user with the service of the server apparatus 2A. In this case, the owner of the traveling battery 62 is, for example, a system administrator or the company that provides the service.

The vehicle information registration processor F1 performs a process for updating various kinds of information registered in the storage 38 to the latest information as appropriate. This process may be implemented by periodically prompting the user to register the latest information or registering the latest information through the user's operation, or may be implemented by automatically performing communication with the vehicle 3.

The problem information reception processor F2 performs a process for receiving, from a vehicle 3 that has encountered a problem at least related to running out of electricity, problem information DT including the content of the problem.

The problem information DT is a series of pieces of information including, for example, information for identifying the disabled vehicle 3T, information for identifying the position of the vehicle 3 that has encountered the problem, that is, the current position of the disabled vehicle 3T, and information on insufficient charge indicating an insufficient amount of remaining battery charge of the disabled vehicle 3T.

The information on insufficient charge may be information directly indicating an insufficient amount of remaining battery charge in a unit such as “kilowatt per hour (kWh)”, or may include information on a distance from the current position of the disabled vehicle 3T to a destination such as a charging station, the current remaining battery charge, and electric efficiency information. Alternatively, the information on insufficient charge may be other information.

The candidate rescue vehicle extraction processor F3 performs a process for extracting vehicles 3 that can rescue the disabled vehicle 3T, as candidate rescue vehicles 3P. The candidate rescue vehicles 3P include, for example, a vehicle 3 traveling around the disabled vehicle 3T, and a vehicle 3 traveling near a route along which the disabled vehicle 3T is scheduled to travel from the current position to the destination.

Current position information of each vehicle 3 is acquired by, for example, the vehicle information acquisition processor F4. Alternatively, the candidate rescue vehicle extraction processor F3 may obtain the current position information of each vehicle 3 by using position information of the vehicle 3 periodically acquired by the vehicle information registration processor F1.

The candidate rescue vehicle extraction processor F3 may further use destination information of each vehicle 3 to extract the candidate rescue vehicles 3P. For example, the candidate rescue vehicle extraction processor F3 may exclude, from the candidate rescue vehicles 3P, a vehicle 3 traveling toward the destination in a direction opposite to its direction toward the current position of the disabled vehicle 3T.

The candidate rescue vehicle extraction processor F3 may extract, as a candidate rescue vehicle 3P, a vehicle 3 for which a delay or an extra travel distance due to a meeting with the disabled vehicle 3T is smaller than a predetermined value, as a result of comparison between a case where the vehicle 3 directly travels toward the destination and a case where the vehicle 3 travels toward the destination after meeting the disabled vehicle 3T.

The candidate rescue vehicle extraction processor F3 may determine whether the remaining charge of the second battery 62B of the vehicle 3 to be used for exchange is greater than or equal to the insufficient charge of the disabled vehicle 3T, and extract the vehicle 3 as a candidate rescue vehicle 3P when the remaining charge of the second battery 62B is greater than or equal to the insufficient charge.

Even when the remaining charge of the second battery 62B of the vehicle 3 is less than the insufficient charge, the candidate rescue vehicle extraction processor F3 may extract the vehicle 3 as a candidate rescue vehicle 3P, if the second battery 62B is charged from the first battery 62A during a driving period by the time when the vehicle 3 meets the disabled vehicle 3T, and secures a remaining charge greater than or equal to the insufficient charge when the vehicle 3 meets the disabled vehicle 3T.

In one example, the candidate rescue vehicle extraction processor F3 fails to extract a vehicle 3 in which the second battery 62B secures a remaining charge greater than or equal to the insufficient charge at the current time point or a vehicle 3 in which the second battery 62B is charged during travel to secure a remaining charge greater than or equal to the insufficient charge. In this case, the candidate rescue vehicle extraction processor F3 may extract, as a candidate rescue vehicle 3P, a vehicle 3 in which the second battery 62B is rapidly charged at the sacrifice of driving performance during travel by the time when the vehicle 3 meets the disabled vehicle 3T to secure a remaining charge greater than or equal to the insufficient charge.

In one example, the candidate rescue vehicle extraction processor F3 fails to extract even a vehicle 3 in which the second battery 62B is rapidly charged to secure a remaining charge greater than or equal to the insufficient charge. In this case, the candidate rescue vehicle extraction processor F3 may finally extract a vehicle 3 in which the second battery 62B is charged after the vehicle 3 meets the disabled vehicle 3T to secure a remaining charge greater than or equal to the insufficient charge.

The candidate rescue vehicles 3P extracted by the candidate rescue vehicle extraction processor F3 may include not only a traveling vehicle 3 and a temporarily parked vehicle 3 but also a vehicle 3 parked at home or in a parking lot. That is, the candidate rescue vehicle extraction processor F3 may extract, as the candidate rescue vehicles 3P, not only a vehicle 3 that is in ready-on mode and can immediately start driving, but also a vehicle 3 that is parked without the driver being present in the driver's seat for a long period of time and is in ready-off mode.

The vehicle information acquisition processor F4 performs a process for acquiring, from the vehicles 3, information useful for the candidate rescue vehicle extraction processor F3 to extract the candidate rescue vehicles 3P.

In one example, the vehicle information acquisition processor F4 acquires the current position information and the destination information of each vehicle 3 used by the candidate rescue vehicle extraction processor F3, the remaining charge, the electric efficiency information, and the like of the first battery 62A and the second battery 62B.

The vehicle information acquisition processor F4 may acquire the information by communicating with each vehicle 3 or by searching the storage 38.

The rescue request information transmission processor F5 transmits rescue request information DA to each of the candidate rescue vehicles 3P extracted from among the vehicles 3.

The rescue request information DA is a series of pieces of information including the current position information of the disabled vehicle 3T or meeting point information indicating a meeting point to meet the disabled vehicle 3T and charge insufficiency information of the second battery 62B of the disabled vehicle 3T.

The charge insufficiency information included in the rescue request information DA may be information expressed in a unit such as “kWh”, which directly indicates the insufficient charge, or may be information expressed in a unit such as “%”, which indicates a value converted into the battery charge level of the second battery 62B of the candidate rescue vehicle 3P.

The rescue request information DA may include information indicating whether the current remaining charge of the second battery 62B of the candidate rescue vehicle 3P is greater than or equal to the insufficient charge, information indicating whether to charge the second battery 62B during travel by the time when the meeting point to meet the disabled vehicle 3T is reached, and information indicating whether to perform a rapid charge at the sacrifice of driving performance.

The rescue vehicle determination processor F6 determines, as the rescue vehicle 3S, one of the candidate rescue vehicles 3P for which the users have accepted, based on the transmitted rescue request information DA, a request for rescuing the disabled vehicle 3T.

For example, the rescue vehicle determination processor F6 may determine, as the rescue vehicle 3S, a candidate rescue vehicle 3P for which the user has first accepted the request among the candidate rescue vehicles 3P.

The rescue vehicle determination processor F6 transmits a notification to the rescue vehicle 3S determined from among the candidate rescue vehicles 3P to indicate its selection as the rescue vehicle 3S.

The fee calculation processor F7 calculates a price to be paid by the disabled vehicle 3T as a “payment fee”, and presents the payment fee to the disabled vehicle 3T or the user of the disabled vehicle 3T. The payment fee is not necessarily money. For example, the fee calculation processor F7 may present a payment fee including service points to be assigned to a user who receives the service provided by the server apparatus 2A or other valuable items.

The fee calculation processor F7 further calculates a price to be received by the rescue vehicle 3S as a “reward”, and presents the reward to the rescue vehicle 3S or the user of the rescue vehicle 3S. The reward to be received by the user of the rescue vehicle 3S is not necessarily money. For example, the fee calculation processor F7 may present a reward including service points or other valuable items.

The fee calculation processor F7 may present the payment fee before transmitting the rescue request information DA to each of the vehicles 3 after receiving the problem information DT from the disabled vehicle 3T.

The fee calculation processor F7 may present the reward when transmitting the rescue request information DA to each of the vehicles 3.

The payment processor F8 performs a process for collecting the payment fee presented by the fee calculation processor F7 from the user of the disabled vehicle 3T and a process for assigning the reward to the user of the rescue vehicle 3S.

These processes may be implemented through the cooperation with, for example, an apparatus different from the server apparatus 2A and managed by another entity such as a bank.

The battery delivery management processor F9 manages the second battery 62B installed in the disabled vehicle 3T or the rescue vehicle 3S. For example, the second battery 62B removed from the rescue vehicle 3S and installed in the disabled vehicle 3T is likely to be originally owned by the user of the rescue vehicle 3S.

In consideration of such a case, the battery delivery management processor F9 manages information for identifying a vehicle 3 in which each second battery 62B is installed. Then, the battery delivery management processor F9 performs a process for storing the second battery 62B received from the disabled vehicle 3T and returning it to the original owner of the second battery 62B.

For example, the battery delivery management processor F9 manages delivery destination information of the second battery 62B in the storage 38. The delivery destination information may be registered in the storage 38 in advance by the vehicle information registration processor F1.

When a fee is charged for the delivery of the second battery 62B, it is desirable that the fee calculation processor F7 calculate a payment fee including the delivery fee.

After the exchange of the second battery 62B, the disabled vehicle 3T reaches the destination and is completely charged. After that, the disabled vehicle 3T is further driven to a location desired by the user, such as a resort or a shopping mall, to fulfill the user's purpose. At any timing thereafter, the user of the disabled vehicle 3T brings the second battery 62B originally owned by the user of the rescue vehicle 3S to a predetermined place such as a rescue station.

At this time, the battery delivery management processor F9 recognizes that the second battery 62B used for the rescue has been delivered to the rescue station in response to input by staff or the like of the rescue station. Then, the battery delivery management processor F9 stores information on the completion of the delivery of the second battery 62B in the storage 38.

The second battery 62B originally owned by the user of the rescue vehicle 3S and brought to the rescue station is delivered to a place designated by the original owner at any timing according to a delivery procedure. The delivery procedure may involve returning the second battery 62B originally owned by the user of the rescue vehicle 3S to the original owner, and receiving the second battery 62B originally installed in the disabled vehicle 3T. The second battery 62B originally installed in the disabled vehicle 3T is brought to the rescue station and returned to the user of the disabled vehicle 3T as necessary.

As described above, upon receiving the problem information DT from the disabled vehicle 3T, the CPU 31 of the server apparatus 2A extracts candidate rescue vehicles 3P in accordance with the content of the problem information DT. Then, the CPU 31 of the server apparatus 2A transmits the rescue request information DA to each of the candidate rescue vehicles 3P, and identifies, among the candidate rescue vehicles 3P, a candidate rescue vehicle 3P for which the user has accepted the rescue request, as the rescue vehicle 3S.

Upon confirming that the rescue has been carried out, the CPU 31 of the server apparatus 2A transmits a payment request to the owner of the disabled vehicle 3T, and pays a reward to the owner of the rescue vehicle 3S.

### 2-4. Functional Configuration of Vehicle

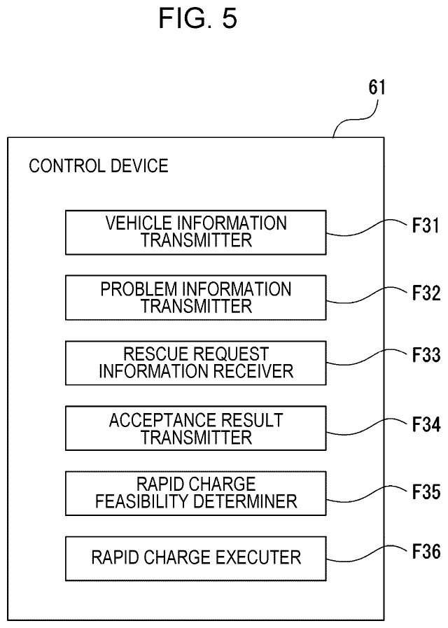

FIG. 5 illustrates an example functional configuration of the vehicle 3.

The control device 61 of the vehicle 3 executes a program to serve as a vehicle information transmitter F31, a problem information transmitter F32, a rescue request information receiver F33, an acceptance result transmitter F34, a rapid charge feasibility determiner F35, and a rapid charge executer F36.

The vehicle information transmitter F31 transmits, to the server apparatus 2A, the remaining charge and the electric efficiency information of the first battery 62A and the second battery 62B as the traveling battery 62 included in the vehicle 3. Other information regarding the vehicle 3, such as information on the manufacturer of the traveling battery 62, the configuration of the traveling battery 62, and the travel distance of the vehicle 3, and the problem information DT, may be transmitted to the server apparatus 2A from the vehicle information transmitter F31 or from a mobile terminal device carried by the user of the vehicle 3.

During parking, the control device 61 of the vehicle 3 does not completely stop the vehicle information transmitter F31, but may keep the vehicle information transmitter F31 in sleep mode that enables periodic transmission of the vehicle information.

The problem information transmitter F32 transmits the problem information DT to the server apparatus 2A through the user's operation or automatically when the vehicle 3 encounters a problem such as running out of electricity. As described above, the problem information DT includes information for identifying the disabled vehicle 3T, information for identifying the position of the disabled vehicle 3T when the problem occurs, and the charge insufficiency information.

The rescue request information receiver F33 receives the rescue request information DA for requesting that the problem encountered by another vehicle 3 be addressed. As described above, the rescue request information DA may include various kinds of information included in the problem information DT transmitted from the disabled vehicle 3T, information indicating whether the remaining charge of the second battery 62B of the vehicle 3 is greater than or equal to the insufficient charge, information indicating the necessity of charging during travel, information indicating the necessity of a rapid charge, and so on.

The acceptance result transmitter F34 transmits information indicating whether to accept the request for rescuing the disabled vehicle 3T to the server apparatus 2A. The information is obtained as a result of the user's input operation to the disabled vehicle 3T.

The rapid charge feasibility determiner F35 performs a process for determining whether to perform a rapid charge during travel by the time when the meeting point to meet the disabled vehicle 3T is reached. Even when a rapid charge is to be performed during travel by the time when the meeting point to meet the disabled vehicle 3T is reached, the rapid charge feasibility determiner F35 may determine not to perform a rapid charge at the sacrifice of driving performance if the rapid charge is determined to be inappropriate.

For example, when a vehicle is traveling on a road on which vehicles are required or recommended to travel at a predetermined speed or higher, the rapid charge is not appropriate.

In a case where the vehicle 3 is required to travel at a predetermined speed or higher, the rapid charge of the second battery 62B at the sacrifice of acceleration performance makes it difficult for the vehicle 3 to travel according to the flow of surrounding vehicles 3, resulting possibly in an increase in risk.

In such a case, the rapid charge feasibility determiner F35 determines not to perform a rapid charge at the sacrifice of driving performance. As a result, the safety of the vehicle 3 can be secured.

The rapid charge executer F36 rapidly charges the second battery 62B by using the remaining charge of the first battery 62A, based on the determination result of the rapid charge feasibility determiner F35.

In the rapid charge by the rapid charge executer F36, for example, the remaining charge per unit time consumed in order for the vehicle 3 to travel is made smaller than that in a case where the second battery 62B is not charged.

For example, driving of the vehicle 3 without the second battery 62B charged is referred to as “normal driving”, driving with the second battery 62B charged normally is referred to as “normal-charging driving”, and driving with the second battery 62B charged rapidly is referred to as “rapid-charging driving”.

The control device 61 causes the PCU 63 to control the traveling battery 62 such that the amount of electric power per unit time consumed for travel is smaller during normal-charging driving than during normal driving and is smaller during rapid-charging driving than during normal-charging driving.

The vehicle information transmitter F31 transmits the information on the vehicle 3 even after the rescue vehicle 3S has rescued the disabled vehicle 3T.

For example, in the disabled vehicle 3T, the vehicle information transmitter F31 transmits, as the rescue result information DR, to the server apparatus 2A, information on the increase in remaining charge through the exchange of the second batteries 62B with the rescue vehicle 3S.

The rescue result information DR can also be obtained for the rescue vehicle 3S in which the second battery 62B is exchanged with the second battery 62B of the disabled vehicle 3T. In one example, for the rescue vehicle 3S, the rescue result information DR can be obtained as the decrease in remaining charge through the exchange, rather than the increase in remaining charge through the exchange.

Accordingly, the rescue result information DR may be transmitted from the vehicle information transmitter F31 of the rescue vehicle 3S to the server apparatus 2A.

If the second battery 62B removed from the disabled vehicle 3T is installed in the rescue vehicle 3S after the remaining charge is deliberately decreased, it is possible to incorrectly determine that the rescue vehicle 3S has supplied the remaining charge more than the actual charge to the disabled vehicle 3T. Therefore, it is likely to be preferable that the rescue result information DR be transmitted from the disabled vehicle 3T in terms of fraud prevention.

It is likely that an attempt will be made to evade payment of the fee for the disabled vehicle 3T through unauthorized rewriting of the program or the like of the disabled vehicle 3T so as not to transmit the rescue result information DR.

Therefore, the rescue result information DR may be transmitted to the server apparatus 2A from both the rescue vehicle 3S and the disabled vehicle 3T. The server apparatus 2A can prevent the fraud described above from occurring by checking the consistency between the rescue result information DR received from the rescue vehicle 3S and the rescue result information DR received from the disabled vehicle 3T.

In the rescue vehicle 3S, the vehicle information transmitter F31 compares the original travel route with a travel route changed due to the rescue of the disabled vehicle 3T, and transmits the extra distance traveled due to the rescue and information on whether a toll road is used to the server apparatus 2A as the rescue result information DR.

The rescue result information DR described above is used for a payment fee calculation process and a reward calculation process performed by the fee calculation processor F7 implemented by the CPU 31 of the server apparatus 2A described above.

### 3. Process Flow

### 3-1. Overall Process Flow

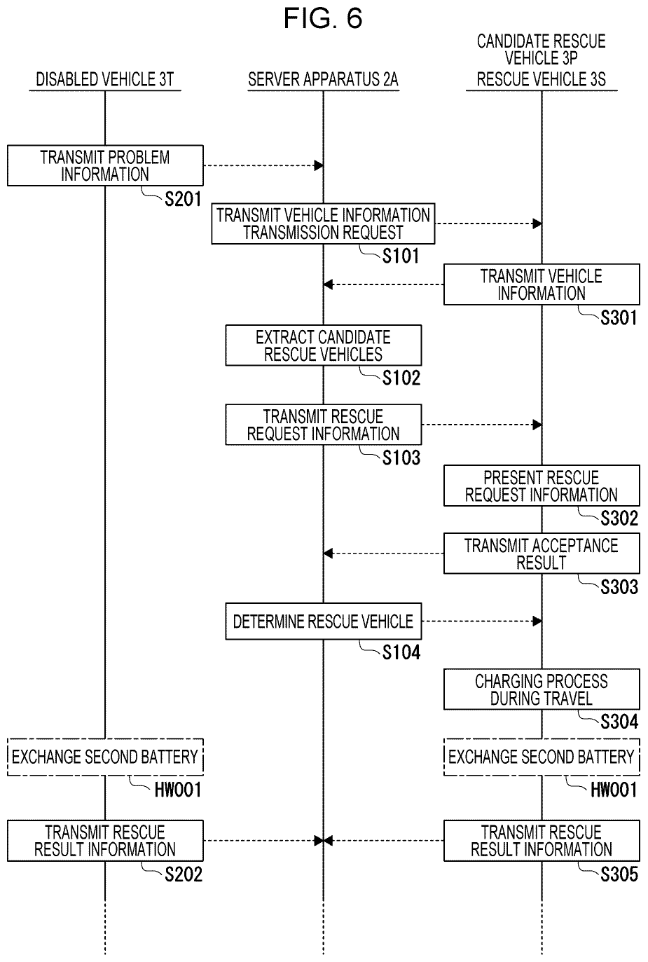

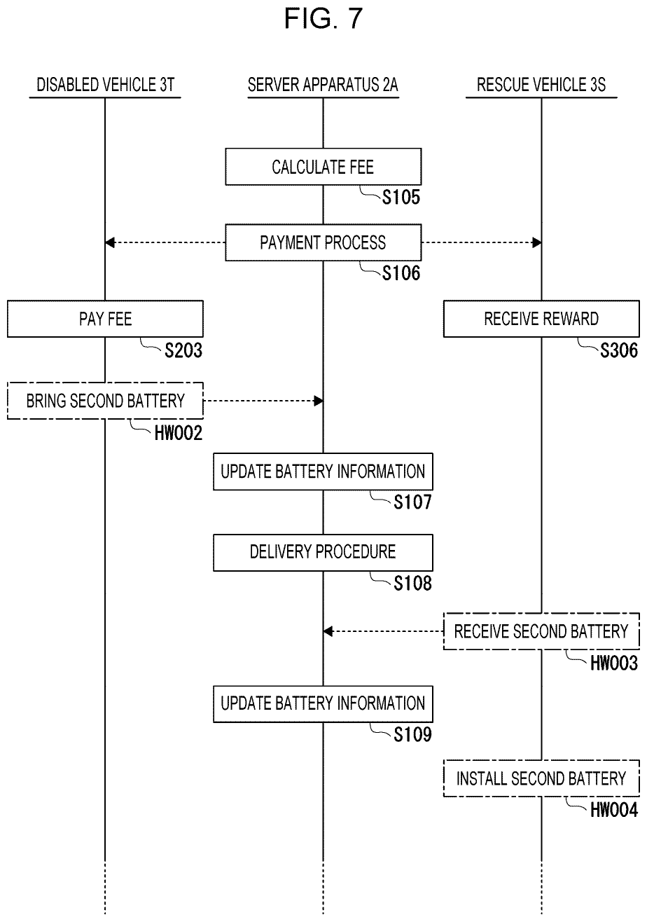

First, an example of the overall flow will be described with reference to FIGS. 6 and 7. FIG. 7 is a diagram illustrating the processing executed as a continuation of FIG. 6. In each of the drawings, the processing indicated by the dashed-line block is performed by hand or manually. In each of the drawings, transmission and reception of information are indicated by a dashed arrow.

First, the user of a vehicle 3 that has encountered a problem (i.e., the disabled vehicle 3T) performs an operation of sending a rescue request to the server apparatus 2A. In response to this operation, in step S201, the control device 61 of the disabled vehicle 3T transmits the problem information DT to the server apparatus 2A.

In step S101, the CPU 31 of the server apparatus 2A, which has received the problem information DT in the processing of step S201, transmits a vehicle information transmission request to each vehicle 3.

The vehicle information transmission request may be transmitted to all the vehicles 3 managed by the server apparatus 2A or to vehicles 3 selected based on the position information of the disabled vehicle 3T. For example, a vehicle 3 traveling in locations away from the current position of the disabled vehicle 3T by 100 km or more is not likely to be appropriate as the rescue vehicle 3S, and thus the vehicle information transmission request is not transmitted to such a vehicle 3. As a result, the amount of communication can be reduced.

In step S301, the control device 61 of each of the vehicles 3 that have received the vehicle information transmission request, including the vehicle 3 determined as the rescue vehicle 3S later, transmits the vehicle information. The vehicle information to be transmitted to the server apparatus 2A may include information on the current position of the vehicle 3, information on the remaining charge of the second battery 62B, and information on the remaining charge of the first battery 62A.

In step S102, the CPU 31 of the server apparatus 2A, which has received the vehicle information, extracts candidate rescue vehicles 3P.

Subsequently, in step S103, the CPU 31 of the server apparatus 2A transmits the rescue request information DA to each of the candidate rescue vehicles 3P.

In step S302, the CPU 31 of each of the candidate rescue vehicles 3P performs a process for presenting the received rescue request information DA to the user.

The user of each of the candidate rescue vehicles 3P, who has viewed the presented rescue request information DA, appropriately operates an operating element provided in the candidate rescue vehicle 3P to show their intention to accept or reject the rescue request.

In response to the user's operation indicating acceptance of the rescue request, in step S303, the control device 61 of the candidate rescue vehicle 3P transmits the acceptance result to the server apparatus 2A.

In step S104, the CPU 31 of the server apparatus 2A, which has received the acceptance result, determines the candidate rescue vehicle 3P as the rescue vehicle 3S, and notifies the rescue vehicle 3S of its determination. The CPU 31 of the server apparatus 2A may also transmit a notification indicating that the rescue vehicle 3S has been determined to the disabled vehicle 3T in addition to the rescue vehicle 3S. The CPU 31 of the server apparatus 2A may notify the other candidate rescue vehicles 3P that the rescue vehicle 3S has been determined.

In step S304, the control device 61 of the rescue vehicle 3S, which has received the notification, charges the second battery 62B by using the first battery 62A during travel. That is, the rescue vehicle 3S performs normal-charging driving or rapid-charging driving. The control device 61 of the rescue vehicle 3S performs rapid-charging driving as appropriate according to the situation.

After the disabled vehicle 3T and the rescue vehicle 3S meet, in manual step HW001, the second batteries 62B of the disabled vehicle 3T and the rescue vehicle 3S are exchanged with each other.

Subsequently, in step S202, the control device 61 of the disabled vehicle 3T transmits the rescue result information DR to the server apparatus 2A. In this processing, for example, information on the increase in remaining charge through the exchange of the second batteries 62B is transmitted to the server apparatus 2A.

In step S305, likewise, the control device 61 of the rescue vehicle 3S transmits the rescue result information DR to the server apparatus 2A. In this processing, for example, the extra distance traveled due to the rescue of the disabled vehicle 3T and information on whether a toll road is used are transmitted to the server apparatus 2A.

The processing of steps S202 and S305 may be performed based on a request from the server apparatus 2A, or may be performed automatically when the completion of the exchange between the second batteries 62B of the vehicles 3 is automatically detected.

Subsequently, the processing illustrated in FIG. 7 will be described.

In step S105, the CPU 31 of the server apparatus 2A calculates a payment fee and a reward based on the received rescue result information DR.

In step S106, the CPU 31 of the server apparatus 2A performs a payment process. This payment process involves a process for collecting the payment fee from the user of the disabled vehicle 3T and a process for assigning the reward to the user of the rescue vehicle 3S.

In step S203, the control device 61 of the disabled vehicle 3T pays the fee. This processing is executed when, for example, the user operates an operating element such as a payment button after confirming the fee displayed on the display 66 of the disabled vehicle 3T.

On the other hand, in step S306, the control device 61 of the rescue vehicle 3S receives the reward. This processing is executed when, for example, the user operates an operating element such as a receipt button after confirming the reward displayed on the display 66 of the rescue vehicle 3S.

The processing after steps S203 and S306 is performed after, for example, the user of the disabled vehicle 3T arrives at the original destination. However, it is conceived that, after arriving at a charging station, the user of the disabled vehicle 3T removes the second battery 62B, which is received from the rescue vehicle 3S, from the disabled vehicle 3T and installs another second battery 62B prepared in the charging station to shorten the charging time. In this case, the processing of manual step HW002 and the subsequent processing may be executed immediately after the disabled vehicle 3T reaches the charging station.

The processing of manual step HW002 is a process in which the user of the disabled vehicle 3T brings the second battery 62B received from the rescue vehicle 3S to a specific place, and is a process in which the control device 61 of the disabled vehicle 3T is not involved.

When the second battery 62B is brought to a predetermined place such as a rescue station, information indicating the action of bringing the second battery 62B to the predetermined place is input manually by the staff or the like of the predetermined place or by the user of the disabled vehicle 3T.

In response to the input of the information, in step S107, the CPU 31 of the server apparatus 2A updates battery information of the second battery 62B, for example, location information of the second battery 62B.

Subsequently, in step S108, the CPU 31 of the server apparatus 2A executes a delivery procedure. Through this processing, a delivery request for the second battery 62B is made to a predetermined delivery company. The delivery destination information of the second battery 62B is stored in, for example, the storage 38 of the server apparatus 2A.

The second battery 62B for which the delivery request is made is delivered to the user of the rescue vehicle 3S that has carried out the rescue of the disabled vehicle 3T. The user receives the second battery 62B in manual step HW003.

Subsequently, the user of the rescue vehicle 3S, the driver of the delivery company, or the like inputs information indicating that the reception of the second battery 62B has been completed.

In response to the input of the information, in step S109, the CPU 31 of the server apparatus 2A updates the location information of the second battery 62B.

In manual step HW004, the user of the rescue vehicle 3S installs the received second battery 62B in the rescue vehicle 3S. As a result, the second battery 62B is installed in the original vehicle 3.

In the illustrated example, the information indicating receipt of the second battery 62B is input manually by the user, the driver of the delivery company, or the like. However, the disclosure is not limited thereto.

For example, when detecting the installment of the second battery 62B in manual step HW004, the control device 61 of the rescue vehicle 3S may perform a process for identifying the installed second battery 62B as the second battery 62B used for the rescue of the disabled vehicle 3T, and may perform a process for notifying the server apparatus 2A that the second battery 62B has returned to the original vehicle 3 according to the result of the identification process.

This saves manual input of information.

### 3-2. Process by Server Apparatus

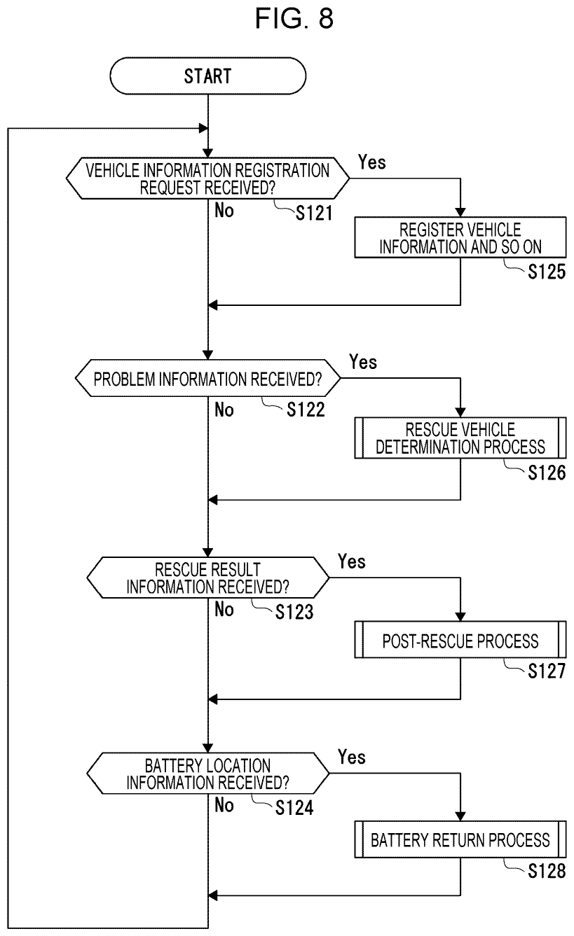

FIG. 8 illustrates an example of a process executed by the server apparatus 2A to implement the process flow illustrated in FIGS. 6 and 7.

The CPU 31 of the server apparatus 2A sequentially executes the determination processes of steps S121, S122, S123, and S124 illustrated in FIG. 8. When each of the determination processes determines an affirmative result (“Yes”), the corresponding process is executed.

The determination process of step S121 is a process for determining whether a vehicle information registration request has been received. The CPU 31 of the server apparatus 2A determines an affirmative result in the determination process of step S121 in accordance with, for example, various kinds of information input by the user for registration in the rescue system 1A.

The determination process of step S122 is a process for determining whether the problem information DT has been received. The CPU 31 of the server apparatus 2A determines an affirmative result in the determination process of step S122 in response to, for example, receipt of a notification indicating the occurrence of a problem from the user of the vehicle 3.

The determination process of step S123 is a process for determining whether the rescue result information DR has been received. For example, the CPU 31 of the server apparatus 2A determines an affirmative result in the determination process of step S123 in response to, for example, receipt of the rescue result information DR from the rescue vehicle 3S or the disabled vehicle 3T after the disabled vehicle 3T has been rescued by the rescue vehicle 3S.

The determination process of step S124 is a process for determining whether the battery location information has been received. The CPU 31 of the server apparatus 2A determines an affirmative result in the determination process of step S124 in response to, for example, receipt of information indicating that the second battery 62B transferred to the disabled vehicle 3T has been brought to a charging station or a rescue station. Further, the CPU 31 of the server apparatus 2A determines an affirmative result in the determination process of step S124 in response to receipt of information indicating that the second battery 62B transferred to the disabled vehicle 3T has been returned to the owner of the rescue vehicle 3S.

If it is determined in step S121 that the vehicle information registration request has been received (“Yes”), in step S125, the CPU 31 of the server apparatus 2A performs a process for registering the vehicle information and so on. The vehicle information and so on include not only information on the vehicle 3 but also information on the user who owns the vehicle 3. In the processing of step S125, furthermore, the CPU 31 of the server apparatus 2A may issue an ID and a password to a newly registered user.

After the processing of step S125, the CPU 31 of the server apparatus 2A proceeds to step S122.

If it is determined in step S122 that the problem information DT has been received from the disabled vehicle 3T (“Yes”), in step S126, the CPU 31 of the server apparatus 2A performs a rescue vehicle determination process.

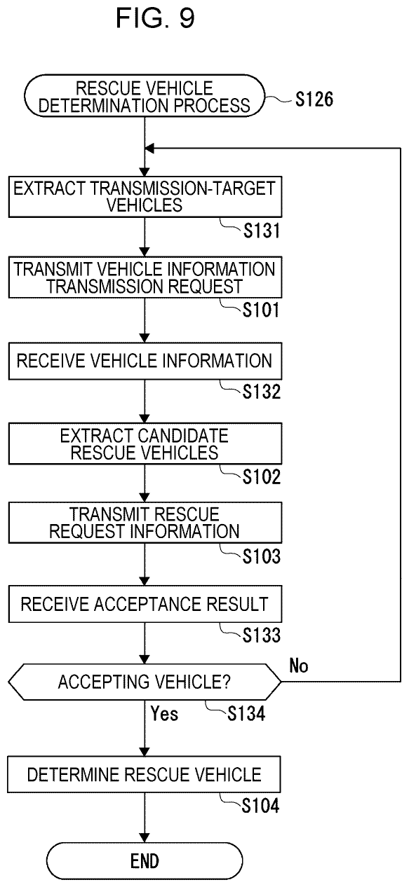

FIG. 9 illustrates details of the rescue vehicle determination process. The processing steps described with reference to FIGS. 6 and 7 are denoted by the same numerals, and a description thereof will be omitted or simplified as appropriate.

In step S131, the CPU 31 of the server apparatus 2A extracts vehicles 3 to which the vehicle information transmission request is to be transmitted (hereinafter referred to as the “transmission-target vehicles”). This processing is a process for, for example, as described above, extracting vehicles 3 located in a certain range around the current position of the disabled vehicle 3T.

In the process for extracting the vehicles 3, the CPU 31 of the server apparatus 2A may use, instead of the current position of the disabled vehicle 3T, a meeting point set between the current position and the destination of the disabled vehicle 3T. That is, the CPU 31 of the server apparatus 2A may calculate the meeting point based on the current position of the disabled vehicle 3T to execute the processing of step S131.

In step S101, the CPU 31 of the server apparatus 2A transmits the vehicle information transmission request to the vehicles 3 determined in step S131.

In step S132, the CPU 31 of the server apparatus 2A receives the vehicle information from each of the vehicles 3. The vehicle information to be received includes information on the current position of the vehicle 3 and information such as the remaining charges of the first battery 62A and the second battery 62B.

The CPU 31 of the server apparatus 2A extracts candidate rescue vehicles 3P in step S102, and transmits the rescue request information DA to the candidate rescue vehicles 3P in step S103.

In step S133, the CPU 31 of the server apparatus 2A receives the acceptance result from the candidate rescue vehicles 3P. It is desirable that a candidate rescue vehicle 3P from which no acceptance result is obtained within a predetermined amount of time be regarded as having rejected the rescue request.

In step S134, the CPU 31 of the server apparatus 2A determines whether any of the candidate rescue vehicles 3P has accepted the rescue request. If none of the candidate rescue vehicles 3P has accepted the rescue request (step S134: No), the disabled vehicle 3T cannot be rescued. Thus, the CPU 31 of the server apparatus 2A returns to step S131, and again performs the process for extracting the transmission-target vehicles.

When the extraction process is performed again, vehicles 3 further away from the current position of the disabled vehicle 3T are also extracted. Alternatively, a vehicle 3 in which a remaining charge greater than or equal to the insufficient charge is not secured by the second battery 62B being charged during travel by the time when the meeting point is reached and further charging is required after the meeting point is reached may be newly extracted when the extraction process is performed again.

If any of the candidate rescue vehicles 3P has accepted the rescue request (step S134: Yes), in step S104, the CPU 31 of the server apparatus 2A determines the candidate rescue vehicle 3P that has first accepted the rescue request as the rescue vehicle 3S.

After the processing operations illustrated in FIG. 9 are completed, the CPU 31 of the server apparatus 2A proceeds to step S123 in FIG. 8.

If it is determined in step S123 that the rescue result information DR has been received from the disabled vehicle 3T or the rescue vehicle 3S (“Yes”), in step S127, the CPU 31 of the server apparatus 2A performs a post-rescue process.

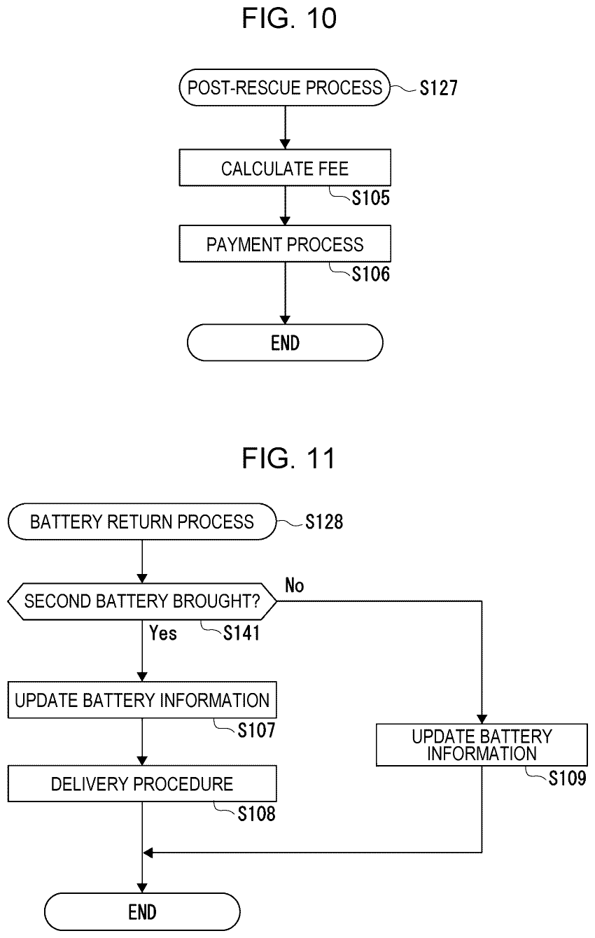

FIG. 10 illustrates details of the post-rescue process. The processing steps described with reference to FIGS. 6 and 7 are denoted by the same numerals, and a description thereof will be omitted or simplified as appropriate.

In the post-rescue process, first, in step S105, the CPU 31 of the server apparatus 2A calculates a payment fee for the user of the disabled vehicle 3T and calculates a reward to be assigned to the user of the rescue vehicle 3S.

Subsequently, in step S106, the CPU 31 of the server apparatus 2A performs a payment process. Through this process, information on the payment fee or the reward is presented on the display 66 of the disabled vehicle 3T or the rescue vehicle 3S, or on a terminal carried by the user of the disabled vehicle 3T or the rescue vehicle 3S. Then, the payment fee is collected or the reward is assigned in accordance with the user's operation.

After the processing operations illustrated in FIG. 10 are completed, the CPU 31 of the server apparatus 2A proceeds to step S124 in FIG. 8.

If it is determined in step S124 that the location information of the second battery 62B has been received (“Yes”), in step S128, the CPU 31 of the server apparatus 2A performs a battery return process.

FIG. 11 illustrates details of the battery return process. The processing steps described with reference to FIGS. 6 and 7 are denoted by the same numerals, and a description thereof will be omitted or simplified as appropriate.

First, in step S141, the CPU 31 of the server apparatus 2A determines whether the second battery 62B installed in the disabled vehicle 3T has been brought to the charging station or the rescue station.

If it is determined that the second battery 62B installed in the disabled vehicle 3T and scheduled to be returned has been brought to the charging station or the rescue station (step S141. Yes), the CPU 31 of the server apparatus 2A updates the battery information, that is, the location information of the second battery 62B, in step S107, and performs the delivery procedure of the second battery 62B in step S108.

On the other hand, if it is determined that the second battery 62B has not been brought to the charging station or the rescue station, but battery location information for which the second battery 62B removed from the disabled vehicle 3T and scheduled to be returned has been returned to the original owner has been received (step S141. No), the CPU 31 of the server apparatus 2A updates the location information of the second battery 62B in step S109.

After the processing operations illustrated in FIG. 11 are completed, the CPU 31 of the server apparatus 2A returns to step S121 in FIG. 8.

By executing the processes illustrated in FIGS. 8 to 11, the CPU 31 of the server apparatus 2A can implement the process flow illustrated in FIGS. 6 and 7.

The processes illustrated in FIGS. 8 to 11 are an example. For example, the rescue vehicle determination process in step S126 may be modified in various ways.

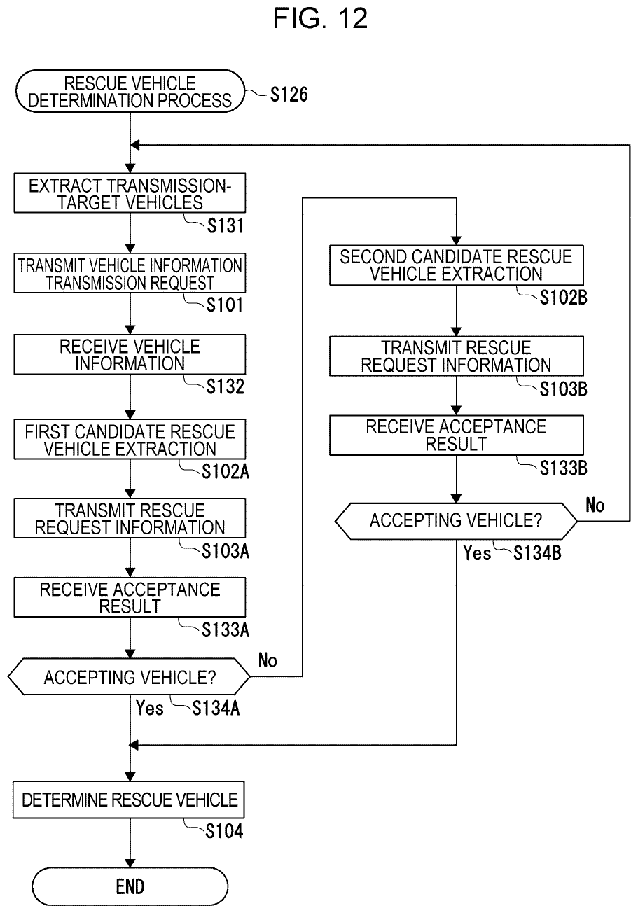

A modification of the rescue vehicle determination process in step S126 will be described with reference to FIG. 12. Processing operations similar to those in FIG. 9 are denoted by the same step numbers, and a description thereof will be omitted as appropriate.

The CPU 31 of the server apparatus 2A executes the processing of steps S131, S101, and S132 to transmit the vehicle information transmission request to vehicles 3 located in a specific range and receives the vehicle information of the vehicles 3.

Subsequently, in step S102A, the CPU 31 of the server apparatus 2A performs a first candidate rescue vehicle extraction process. The first candidate rescue vehicle extraction process extracts, for example, a vehicle 3 in which the remaining charge of the second battery 62B is greater than or equal to the insufficient charge, and a vehicle 3 in which the second battery 62B is charged normally during travel to ensure a remaining charge equal to the insufficient charge when the meeting point is reached.

The CPU 31 of the server apparatus 2A executes the processing of steps S103A and S133A to determine the vehicles 3 extracted in step S102A as the candidate rescue vehicles 3P, transmit the rescue request information DA to each of the candidate rescue vehicles 3P, and receive the acceptance result. The processing of steps S103A and S133A is similar to the processing of steps S103 and S133.

A description of a case where it is determined that an accepting vehicle is present in the subsequent processing of step S134A will be omitted.

If it is determined in step S134A that no accepting vehicle is present, in step S102B, the CPU 31 of the server apparatus 2A executes a second candidate rescue vehicle extraction process. The second candidate rescue vehicle extraction process extracts a vehicle 3 in which the second battery 62B is charged rapidly during travel to ensure a remaining charge equal to the insufficient charge when the meeting point is reached.

Subsequently, the CPU 31 of the server apparatus 2A executes the processing of steps S103B and S133B. The processing of steps S103B and S133B is similar to the processing of steps S103 and S133.

A description of a case where it is determined that an accepting vehicle is present in the subsequent processing of step S134B will be omitted.

On the other hand, if it is determined in the processing of step S134B that no accepting vehicle is present, the CPU 31 of the server apparatus 2A returns to step S131, and again performs the process for extracting the transmission-target vehicles.

If it is determined in the processing of step S134B that no accepting vehicle is present, the CPU 31 of the server apparatus 2A may further execute a third candidate rescue vehicle extraction process. In this extraction process, a candidate rescue vehicle 3P in which the second battery 62B is continuously charged after the meeting point is reached to secure a remaining charge greater than or equal to the insufficient charge is extracted.

### 3-3. Process by Vehicle

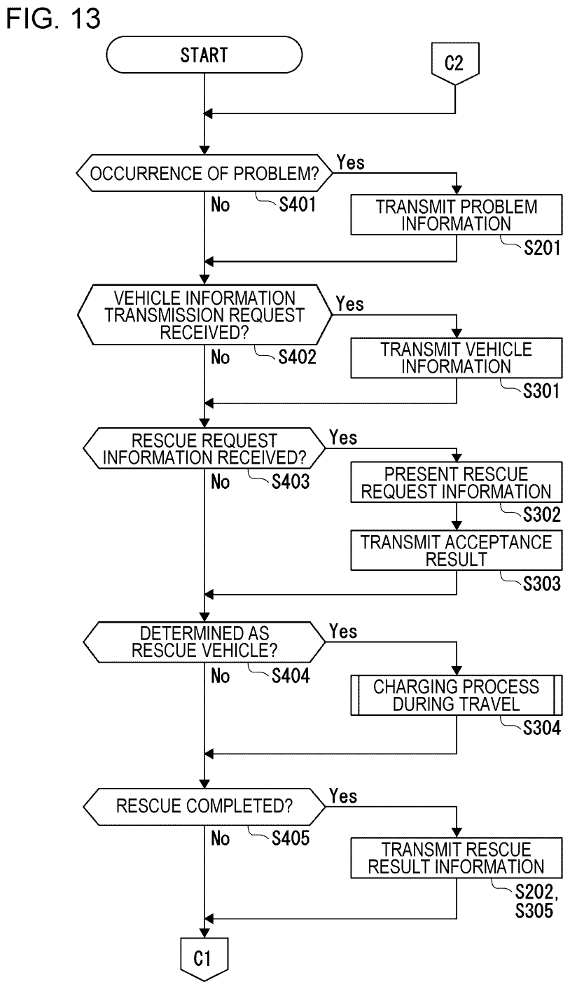

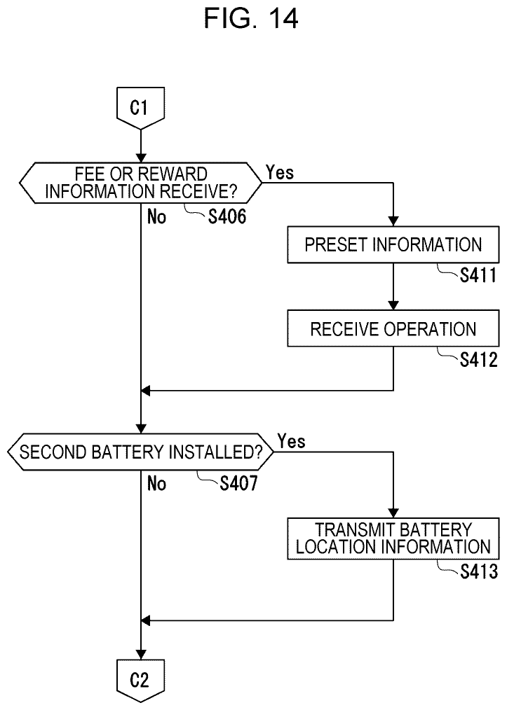

FIGS. 13 and 14 illustrate an example of a process executed by the vehicle 3 to implement the process flow illustrated in FIGS. 6 and 7. In FIGS. 13 and 14, connectors C1 and C2 are used to indicate links between processing operations.

The control device 61 of the vehicle 3 sequentially executes the determination processes of steps S401, S402, S403, S404, and S405 in FIG. 13 and steps S406 and S407 in FIG. 14. When each of the determination processes determines an affirmative result (“Yes”), the corresponding process is executed.

The determination process of step S401 is a process for determining whether a problem has occurred. If an operation for providing a notification of the occurrence of a problem is performed by the user or if it is determined that the original destination cannot be reached due to the vehicle 3 running out of electricity, the control device 61 of the vehicle 3 determines an affirmative result in the determination process of step S401.

The determination process of step S402 is a process for determining whether the vehicle information transmission request has been received from the server apparatus 2A. If the vehicle information transmission request has been received from the server apparatus 2A, the control device 61 of the vehicle 3 determines an affirmative result in the determination process of step S402.

The determination process of step S403 is a process for determining whether the rescue request information DA has been received from the server apparatus 2A. If the rescue request information DA has been received from the server apparatus 2A, the control device 61 of the vehicle 3 determines an affirmative result in the determination process of step S403.

The determination process of step S404 is a process for determining whether the vehicle 3 is determined as the rescue vehicle 3S. If information indicating that the vehicle 3 is determined as the rescue vehicle 3S has been received from the server apparatus 2A, the control device 61 of the vehicle 3 determines an affirmative result in the determination process of step S404.

The determination process of step S405 is a process for determining whether the rescue of the disabled vehicle 3T has been completed. If it is determined that the rescue of the disabled vehicle 3T has been completed, the control device 61 of the vehicle 3 determines an affirmative result in the determination process of step S405.

The determination process of step S406 in FIG. 14 is a process for determining whether payment fee information or reward information has been received from the server apparatus 2A. If payment fee information or reward information has been received from the server apparatus 2A, the control device 61 of the vehicle 3 determines an affirmative result in the determination process of step S406.

The determination process of step S407 is a process for determining whether the second battery 62B has been installed. If the second battery 62B used to rescue the disabled vehicle 3T has been re-installed, the control device 61 of the vehicle 3 determines an affirmative result in the determination process of step S407.

If it is determined in step S401 of FIG. 13 that a problem has occurred in the vehicle 3 (“Yes”), in step S201, the control device 61 of the vehicle 3 transmits the problem information DT to the server apparatus 2A. The problem information DT includes the position information of the vehicle 3, which has become the disabled vehicle 3T, and the information on the remaining charge. The problem information DT may further include position information of the nearest charging station or information on a distance to the charging station.

After the processing of step S201, the control device 61 of the vehicle 3 proceeds to step S402.

If it is determined in step S402 that the vehicle information transmission request has been received (“Yes”), in step S301, the control device 61 of the vehicle 3 transmits the vehicle information to the server apparatus 2A.

After the processing of step S301, the control device 61 of the vehicle 3 proceeds to step S403.

If it is determined in step S403 that the rescue request information DA has been received from the server apparatus 2A (“Yes”), the control device 61 of the vehicle 3 performs a process for presenting the rescue request information DA to the user in step S302, and performs a process for transmitting an acceptance result as a result of the user's operation to the server apparatus 2A in step S303.

After the processing of step S303, the control device 61 of the vehicle 3 proceeds to step S404.

If it is determined in step S404 that information notifying that the vehicle 3 is determined as the rescue vehicle 3S has been received from the server apparatus 2A (“Yes”), in step S304, the control device 61 of the vehicle 3 performs a charging process during travel.

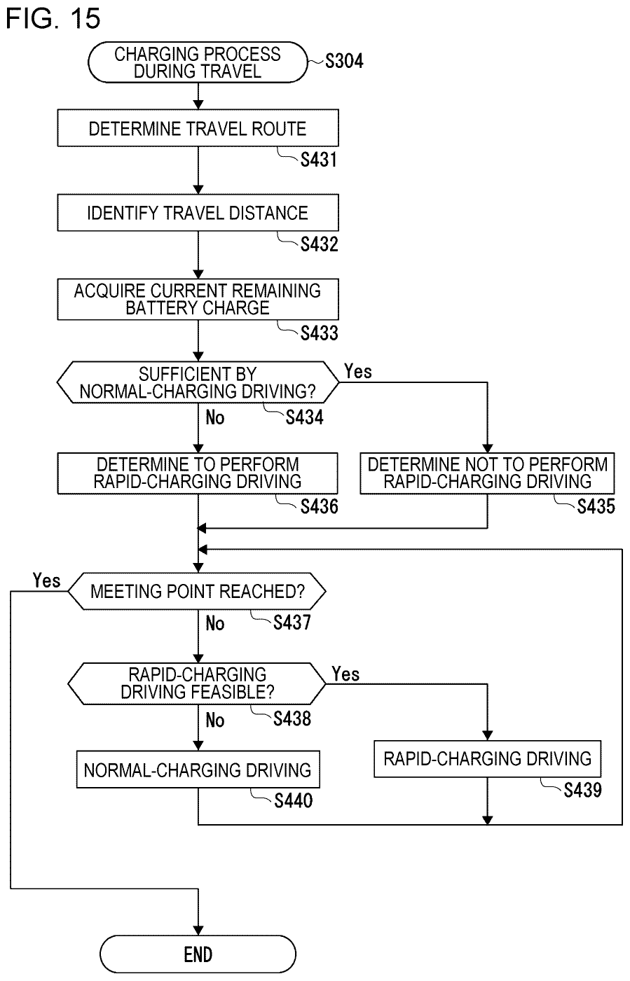

FIG. 15 illustrates details of the charging process during travel.

In the charging process during travel, in FIG. 15, first, in step S431, the control device 61 of the vehicle 3 serving as the rescue vehicle 3S determines a travel route according to the meeting point to meet the disabled vehicle 3T. In one example, the control device 61 of the rescue vehicle 3S may present several candidates to the user and select a route selected by the user from among the candidates as the travel route. In another example, the control device 61 of the rescue vehicle 3S may select a route designated by the server apparatus 2A in consideration of charging control during travel as the travel route.

In step S432, the control device 61 of the rescue vehicle 3S identifies the travel distance based on the travel route.

In step S433, the control device 61 of the rescue vehicle 3S acquires information on the current remaining charge of the second battery 62B.

In step S434, the control device 61 of the rescue vehicle 3S determines whether the insufficient charge is fully compensated for by normal-charging driving.

If the remaining charge of the second battery 62B at the time point when the rescue vehicle 3S reaches the meeting point through normal-charging driving or the remaining charge of the second battery 62B at the time point when the rescue vehicle 3S reaches the meeting point without the second battery 62B charged during travel is greater than or equal to the insufficient charge, the control device 61 of the rescue vehicle 3S determines “Yes” in the determination process of step S434.

For example, if the distance between the current position of the rescue vehicle 3S and the meeting point is shorter than a predetermined distance, “No” may be determined in the determination process of step S434.

If it is determined that the insufficient charge is fully compensated for by normal-charging driving (step S434: Yes), in step S435, the control device 61 of the rescue vehicle 3S determines not to perform rapid-charging driving. This process is implemented by, for example, a process of setting “0” in a flag indicating whether rapid-charging driving is feasible.

On the other hand, if it is determined that the insufficient charge is not fully compensated for by normal-charging driving (step S434: No), in step S436, the control device 61 of the rescue vehicle 3S determines to perform rapid-charging driving. This process is implemented by, for example, a process of setting “1” in the flag indicating whether rapid-charging driving is feasible.

The matters determined in step S435 or S436 may be appropriately changed. For example, even when the execution of rapid-charging driving is determined in step S436, if the vehicle cannot travel on the scheduled travel route due to an accident or a construction and is forced to detour, the charging time increases and thus rapid-charging driving may no longer be necessary.

After the completion of the processing of step S436 or S435, in step S437, the control device 61 of the rescue vehicle 3S determines whether the meeting point to meet the disabled vehicle 3T has been reached. This determination process may be performed based on the user's operation or information from the map locator.

The control device 61 of the rescue vehicle 3S determines “No” in the processing of step S437 until the meeting point is reached.

At this time, in step S438, the control device 61 of the rescue vehicle 3S further determines whether rapid-charging driving is feasible.

Rapid-charging driving is feasible when the following two conditions are both satisfied.

The first condition is a condition in which it is determined in step S436 that rapid-charging driving is feasible and then the determination is not changed.

The second condition is a condition in which the rescue vehicle 3S is not traveling on a road on which vehicles are required to travel at a predetermined speed or higher or a road on which vehicles are recommended to travel at a predetermined speed or higher.

If these two conditions are both satisfied, the control device 61 of the rescue vehicle 3S determines “Yes” in step S438.

On the other hand, if at least one of the two conditions is not satisfied, the control device 61 of the rescue vehicle 3S determines “No” in step S438.

If it is determined that rapid-charging driving is feasible (step S438: Yes), the control device 61 of the rescue vehicle 3S performs rapid-charging driving in step S439, and returns to the determination process of step S437.

On the other hand, if it is determined that rapid-charging driving is not feasible (step S438: No), the control device 61 of the rescue vehicle 3S performs normal-charging driving in step S440, and returns to the determination process of step S437.

As is understood from FIG. 15, the control device 61 of the rescue vehicle 3S repeatedly executes the determination process of step S438 until the rescue vehicle 3S reaches the meeting point to meet the disabled vehicle 3T. This makes it possible to implement flexible processing such that the rescue vehicle 3S performs normal-charging driving in step S440 during travel on an expressway and performs rapid-charging driving in step S439 during travel on an ordinary road.

The remaining charge consumed in order for the rescue vehicle 3S to travel is mainly the remaining charge stored in the first battery 62A. If a sufficient remaining charge is secured by the second battery 62B, the remaining charge of the second battery 62B may be used for the rescue vehicle 3S to travel to the extent that the remaining charge can compensate for the insufficient charge.

The control device 61 of the rescue vehicle 3S appropriately executes the processing of step S439. Thus, the remaining charge of the first battery 62A per unit time consumed for travel is smaller when the second battery 62B is being charged by the first battery 62A than when the second battery 62B is not being charged by the first battery 62A.

If it is determined in step S437 that the meeting point is reached (step S437: Yes), the control device 61 of the rescue vehicle 3S ends the series of processing operations illustrated in FIG. 15.

After the processing operations illustrated in FIG. 15 are completed, the control device 61 of the vehicle 3 serving as the rescue vehicle 3S proceeds to step S405 in FIG. 13.

If it is determined in step S405 that the rescue of the disabled vehicle 3T has been completed (“Yes”), in step S202 or S305, the control device 61 of the vehicle 3 transmits the rescue result information DR to the server apparatus 2A.

In one example, when the vehicle 3 is the disabled vehicle 3T, the rescue result information DR is transmitted to the server apparatus 2A in step S202. When the vehicle 3 is the rescue vehicle 3S, the rescue result information DR is transmitted to the server apparatus 2A in step S305.

After the processing of step S202 or S305, the control device 61 of the vehicle 3 proceeds to step S406 in FIG. 14.

If it is determined in step S406 that information related to the payment fee or the reward has been received from the server apparatus 2A (“Yes”), the control device 61 of the vehicle 3 performs a process for presenting the information related to the payment fee or the reward to the user in step S411, and performs a process for receiving the user's operation in step S412.

The user's operation in step S412 is not essential, and a withdrawal of the payment fee or an assignment of the reward may be automatically performed.

After the processing of step S412, the control device 61 of the vehicle 3 proceeds to step S407.

If it is determined in step S407 that the second battery 62B used for the rescue of the disabled vehicle 3T has been installed (“Yes”), in step S413, the control device 61 of the vehicle 3 performs a process for transmitting the location information of the second battery 62B to the server apparatus 2A.

In this process, the control device 61 of the rescue vehicle 3S automatically detects that the second battery 62B passed to the disabled vehicle 3T has been re-installed in the rescue vehicle 3S, and automatically transmits the location information of the second battery 62B to the server apparatus 2A.

After the processing of step S413, the control device 61 of the vehicle 3 returns to step S401 in FIG. 13.

### 4. Second Embodiment

The first embodiment describes an example in which the rescue vehicle 3S is responsible for independently rescuing the disabled vehicle 3T. A second embodiment provides an example in which a group of two or more rescue vehicles 3S is responsible for rescuing the disabled vehicle 3T.

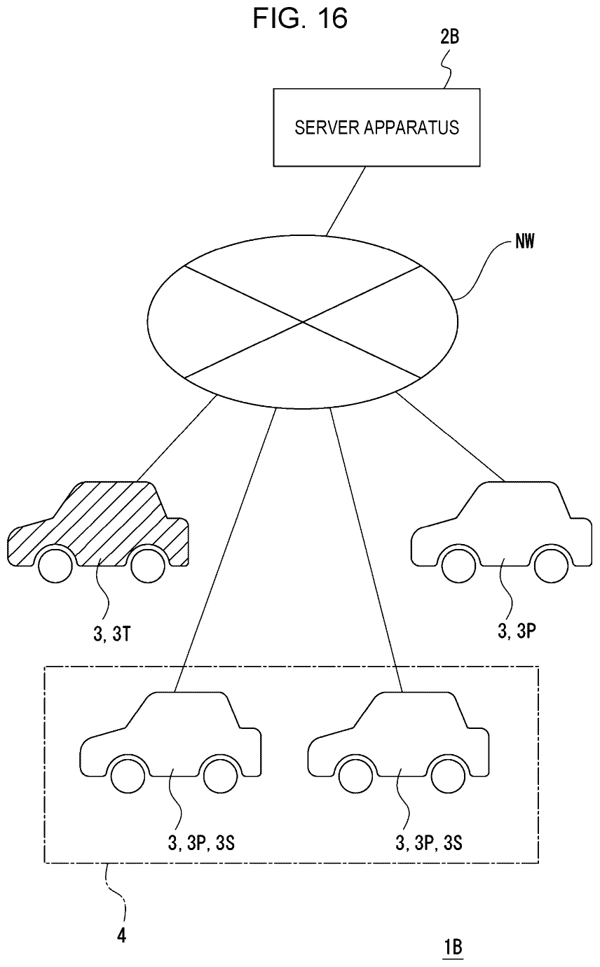

FIG. 16 illustrates an example configuration of a rescue system 1B according to the present embodiment.

The rescue system 1B includes a server apparatus 2B and vehicles 3. The vehicles 3 included in the rescue system 1B include a disabled vehicle 3T and candidate rescue vehicles 3P extracted from the other vehicles 3.

Further, the server apparatus 2B determines candidate rescue vehicles 3P as rescue vehicles 3S. The determined rescue vehicles 3S are a joint rescue candidate group 4 responsible for jointly rescuing the disabled vehicle 3T. That is, the server apparatus 2B creates the joint rescue candidate group 4 including the rescue vehicles 3S.

The server apparatus 2B implements the functions illustrated in FIG. 4 by the CPU 31 executing a predetermined program. That is, the server apparatus 2B serves as the vehicle information registration processor F1, the problem information reception processor F2, the candidate rescue vehicle extraction processor F3, the vehicle information acquisition processor F4, the rescue request information transmission processor F5, the rescue vehicle determination processor F6, the fee calculation processor F7, the payment processor F8, and the battery delivery management processor F9.

A description of functions similar to those of the first embodiment will be omitted as appropriate, and differences will mainly be described.

The candidate rescue vehicle extraction processor F3 prepares the joint rescue candidate group 4 responsible for rescuing the disabled vehicle 3T such that candidate rescue vehicles 3P belong to the joint rescue candidate group 4.

The candidate rescue vehicle extraction processor F3 may create joint rescue candidate groups 4. For example, the candidate rescue vehicle extraction processor F3 creates a first group 4X and a second group 4Y as joint rescue candidate groups 4 such that candidate rescue vehicles 3P belonging to one of the first group 4X and the second group 4Y are different from those belonging to the other.

Several methods are considered for selecting candidate rescue vehicles 3P belonging to the first group 4X and candidate rescue vehicles 3P belonging to the second group 4Y.

In one example, the insufficient charge included in the problem information DT received by the problem information reception processor F2 from the disabled vehicle 3T is, for example, “100”. Since the description is schematic, the insufficient charge and the remaining charge will be described without units. The insufficient charge, which is “100”, is a numerical value obtained by subtracting the remaining charge left in the disabled vehicle 3T from the remaining charge required for the disabled vehicle 3T to reach the nearest charging station. The nearest charging station is referred to as a destination DP.

First, the candidate rescue vehicle extraction processor F3 generates the first group 4X. Then, the candidate rescue vehicle extraction processor F3 determines the remaining charge to be secured by the candidate rescue vehicles 3P, as secured remaining charge. Here, it is assumed that the candidate rescue vehicle extraction processor F3 determines that the secured remaining charge is “60”.

The candidate rescue vehicle extraction processor F3 selects, as a first candidate rescue vehicle 3P belonging to the first group 4X, a candidate rescue vehicle 3P1 in which the remaining charge of the second battery 62B at the time of meeting the disabled vehicle 3T is “60”. Further, the candidate rescue vehicle extraction processor F3 sets a meeting point at which the candidate rescue vehicle 3P1 and the disabled vehicle 3T meet, as a first meeting point MP1.

Subsequently, the candidate rescue vehicle extraction processor F3 sets a second meeting point MP2 at a position that can be reached by the disabled vehicle 3T traveling from the first meeting point MP1 using the remaining charge “60”. It is desirable that the second meeting point MP2 be located between the first meeting point MP1 and the destination DP and set in a location far from the first meeting point MP1.

The candidate rescue vehicle extraction processor F3 selects, as a candidate rescue vehicle 3P2, a candidate rescue vehicle 3P in which the remaining charge of the second battery 62B at the time when the second meeting point MP2 is reached is greater than or equal to “40”.

As a result, the candidate rescue vehicles 3P1 and 3P2 are the candidate rescue vehicles 3P belonging to the first group 4X.

Next, the candidate rescue vehicle extraction processor F3 generates the second group 4Y. Then, the remaining charge to be secured by the candidate rescue vehicles 3P is determined as secured remaining charge. Here, it is assumed that the candidate rescue vehicle extraction processor F3 determines that the secured remaining charge is “50”.

It is assumed that the candidate rescue vehicle extraction processor F3 selects, as a first candidate rescue vehicle 3P belonging to the second group 4Y, a candidate rescue vehicle 3P3 in which the remaining charge of the second battery 62B at the time of meeting the disabled vehicle 3T is “50”. Further, the candidate rescue vehicle extraction processor F3 sets a meeting point at which the candidate rescue vehicle 3P3 and the disabled vehicle 3T meet, as a first meeting point MP1′.

Subsequently, the candidate rescue vehicle extraction processor F3 sets a second meeting point MP2′ at a position that can be reached by the disabled vehicle 3T traveling from the first meeting point MP1′ using the remaining charge “50”. It is desirable that the second meeting point MP2′ be located between the first meeting point MP1′ and the destination DP and set in a location far from the first meeting point MP1′.

The candidate rescue vehicle extraction processor F3 selects, as a candidate rescue vehicle 3P4, a candidate rescue vehicle 3P in which the remaining charge of the second battery 62B at the time when the second meeting point MP2′ is reached is greater than or equal to “50”.

As a result, the candidate rescue vehicles 3P3 and 3P4 are the candidate rescue vehicles 3P belonging to the second group 4Y.

The first meeting points MP1 and MP1′ may be set at positions that are located between the current position and the destination DP of the disabled vehicle 3T and that can be traveled using the current remaining charge.

The candidate rescue vehicle extraction processor F3 generates joint rescue candidate groups 4 in the way described above. The candidate rescue vehicle extraction processor F3 may generate one joint rescue candidate group 4 when joint rescue candidate groups 4 are difficult to generate.

As described above, the candidate rescue vehicle extraction processor F3 determines the first meeting point MP1 (MP1′) and the second meeting point MP2 (MP2′), creates the joint rescue candidate group 4, determines the secured remaining charge for each of the candidate rescue vehicles 3P belonging to the joint rescue candidate group 4, and extracts the candidate rescue vehicles 3P belonging to the joint rescue candidate group 4.

The candidate rescue vehicle extraction processor F3 executes the processes by using the information on each of the vehicles 3 acquired by the vehicle information registration processor F1 or the vehicle information acquisition processor F4.

The candidate rescue vehicle extraction processor F3 may acquire, from the disabled vehicle 3T, information on a route along which the disabled vehicle 3T travels to the destination DP, or may calculate the information on the route based on map information.

Further, the candidate rescue vehicle extraction processor F3 calculates travel routes from the candidate rescue vehicles 3P to the respective meeting points, based on the map information.

The rescue request information transmission processor F5 transmits the rescue request information DA to each of the candidate rescue vehicles 3P belonging to the joint rescue candidate group 4 created by the candidate rescue vehicle extraction processor F3. The rescue request information DA includes information on the meeting point and information on the secured remaining charge for each of the candidate rescue vehicles 3P. The rescue request information DA may further include route information to the respective meeting points.

Based on the respective acceptance results received from the candidate rescue vehicles 3P, the rescue vehicle determination processor F6 determines a joint rescue candidate group 4 responsible for rescuing the disabled vehicle 3T. That is, the rescue vehicle determination processor F6 determines, for each joint rescue candidate group 4, whether to determine the candidate rescue vehicles 3P belonging to the joint rescue candidate group 4, as rescue vehicles 3S.

For example, in the example described above, the candidate rescue vehicle 3P1 belonging to the first group 4X and the candidate rescue vehicle 3P3 belonging to the second group 4Y have accepted the rescue request, but the candidate rescue vehicle 3P2 belonging to the first group 4X and the candidate rescue vehicle 3P4 belonging to the second group 4Y have rejected the rescue request. In this case, the rescue vehicle determination processor F6 determines not to use either the first group 4X or the second group 4Y as rescue vehicles 3S for rescuing the disabled vehicle 3T.

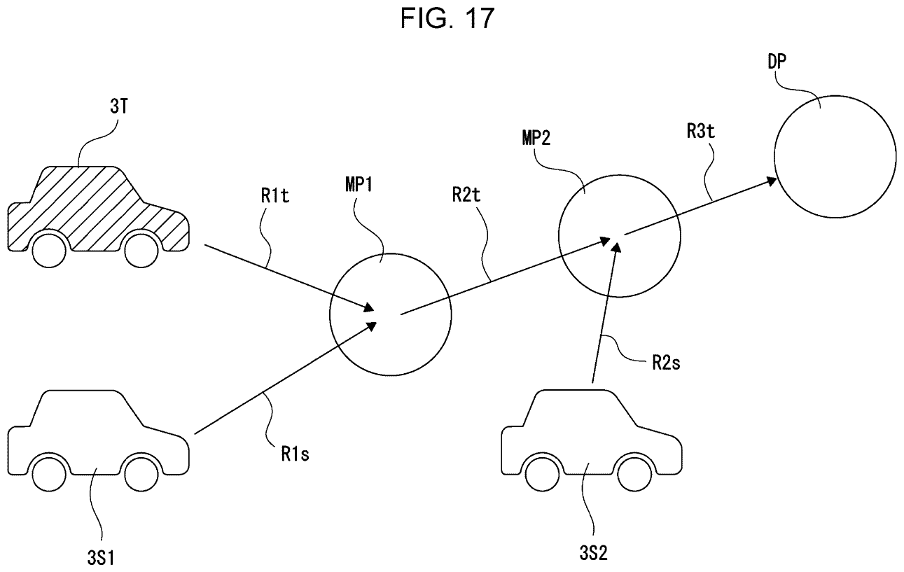

FIG. 17 illustrates a case where it is determined that the first group 4X is responsible for rescuing the disabled vehicle 3T. That is, the rescue vehicle determination processor F6 determines the candidate rescue vehicle 3P1 as a rescue vehicle 3S1, and determines the candidate rescue vehicle 3P2 as a rescue vehicle 3S2.

In this case, the disabled vehicle 3T receives information on the first meeting point MP1 and the second meeting point MP2 from the server apparatus 2B. The disabled vehicle 3T may further receive information on a route R1t from the current position to the first meeting point MP1 and information on a route R2t from the first meeting point MP1 to the second meeting point MP2.

The disabled vehicle 3T may further receive, from the server apparatus 2B, information on the rescue vehicle 3S1 that meets at the first meeting point MP1 and the driver thereof, and information on the rescue vehicle 3S2 that meets at the second meeting point MP2 and the driver thereof.

The rescue vehicle 3S1 appropriately receives, from the server apparatus 2B, information on the first meeting point MP1, information on a route R1s to the first meeting point MP1, and information on the secured remaining charge “60”.

Likewise, the rescue vehicle 3S2 appropriately receives, from the server apparatus 2B, information on the second meeting point MP2, information on a route R2s to the second meeting point MP2, and information on the secured remaining charge “40”.

The disabled vehicle 3T and the rescue vehicle 3S1, traveling on the route R1t and the route R1s, respectively, move to the first meeting point MP1. The disabled vehicle 3T and the rescue vehicle 3S1 meet at the first meeting point MP1.

The disabled vehicle 3T and the rescue vehicle 3S1 exchange the second batteries 62B with each other. As a result, the disabled vehicle 3T can obtain the second battery 62B whose remaining charge is “60”.

Further, the disabled vehicle 3T and the rescue vehicle 3S2, traveling on the route R2t and the route R2s, respectively, move to the second meeting point MP2. The disabled vehicle 3T and the rescue vehicle 3S2 meet at the second meeting point MP2.

The disabled vehicle 3T and the rescue vehicle 3S2 exchange the second batteries 62B with each other. As a result, the disabled vehicle 3T can newly obtain the second battery 62B whose remaining charge is “40”.

The disabled vehicle 3T travels on a route R3t using the remaining charge, namely, “40”, and moves to the destination DP.

When the disabled vehicle 3T reaches the charging station as the destination DP, the first battery 62A and the second battery 62B can be charged.

The overall flow according to the present embodiment will be described with reference to FIGS. 6 and 7. Differences from the first embodiment will mainly be described. In FIGS. 6 and 7, the “server apparatus 2A” is read as the “server apparatus 2B” to describe an example of the present embodiment.

In step S102, the server apparatus 2B extracts candidate rescue vehicles 3P in consideration of the first meeting point MP1, the second meeting point MP2, and the secured remaining charge. Further, the server apparatus 2B generates a joint rescue candidate group 4 to which the candidate rescue vehicles 3P extracted in step S102 belong.

In step S103, the server apparatus 2B transmits the rescue request information DA to each joint rescue candidate group 4.

In step S104, the server apparatus 2B determines whether to use the candidate rescue vehicles 3P of each joint rescue candidate group 4 as rescue vehicles 3S.

The server apparatus 2B implements the predetermined functions illustrated in FIG. 4 by the CPU 31 executing the processing operations illustrated in FIG. 8.

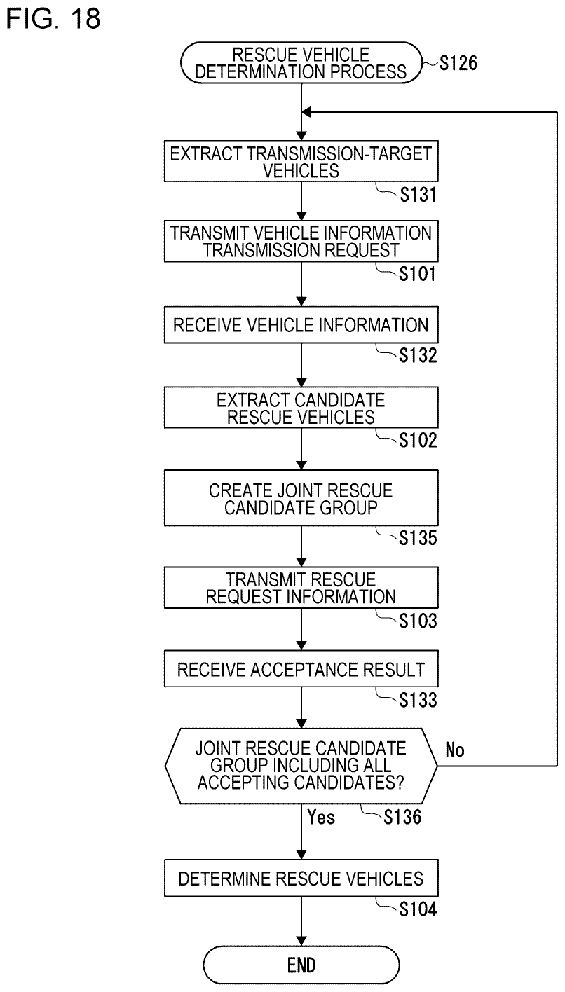

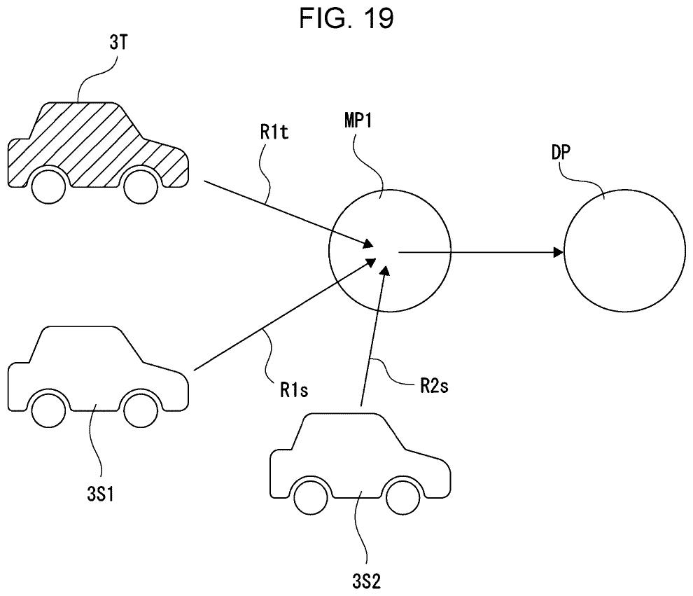

FIG. 18 illustrates a modification of the example illustrated in FIG. 9 for the processing of step S126 executed by the CPU 31 of the server apparatus 2B. Processing operations similar to those in FIG. 9 are denoted by the same step numbers, and a description thereof will be omitted as appropriate.

A description of the processing of steps S131, S101, S132, 5102 illustrated in FIG. 18 will be omitted.

In step S135, the CPU 31 of the server apparatus 2B creates joint rescue candidate groups 4. In the processing of step S135, the CPU 31 of the server apparatus 2B creates joint rescue candidate groups 4 and determines candidate rescue vehicles 3P belonging to each of the joint rescue candidate groups 4.

A description of the processing of steps S103 and S133 will be omitted.

In step S136, the CPU 31 of the server apparatus 2B determines whether a joint rescue candidate group 4 in which all of the candidate rescue vehicles 3P have accepted the rescue request is present.

If in all of the joint rescue candidate groups 4, at least one or more candidate rescue vehicles 3P have refused the rescue request, the CPU 31 of the server apparatus 2B determines “No” in step S136.

If the determination result is “No” in step S136, the CPU 31 of the server apparatus 2B returns to step S131.

On the other hand, if the determination result is “Yes” in step S136, the CPU 31 of the server apparatus 2B proceeds to step S104 and determines rescue vehicles 3S.

The processing of steps S127 and S128 in FIG. 8 is the same as that in the first embodiment except for the number of rescue vehicles 3S to be determined, and thus a description thereof will be omitted.

The processes executed by the control device 61 of each of the rescue vehicles 3S are similar to the processes illustrated in FIGS. 13, 14, and 15.

### 5. Modifications

Modifications of the examples described above will be described.

### 5-1. First Modification

In a first modification, as in the second embodiment, rescue vehicles 3S belonging to a joint rescue candidate group 4 are responsible for jointly rescuing the disabled vehicle 3T.

The difference from the second embodiment is that, for example, when the two rescue vehicles 3S1 and 3S2 are responsible for jointly rescuing the disabled vehicle 3T, as illustrated in FIG. 19, the disabled vehicle 3T, the rescue vehicle 3S1, and the rescue vehicle 3S2 meet at the first meeting point MP1.

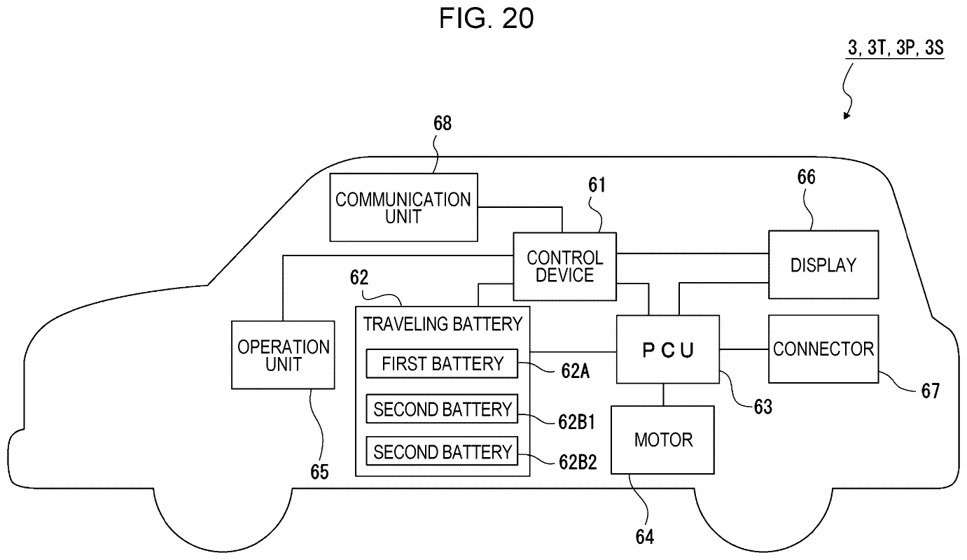

FIG. 20 illustrates a configuration of a vehicle 3 according to the present modification. FIG. 20 corresponds to FIG. 3, and a description of the same components as those in FIG. 3 will be omitted.

The vehicle 3 includes, as a traveling battery 62, one first battery 62A and second batteries 62B. In the example illustrated in FIG. 20, the vehicle 3 includes two second batteries 62B, namely, a second battery 62B1 and a second battery 62B2.

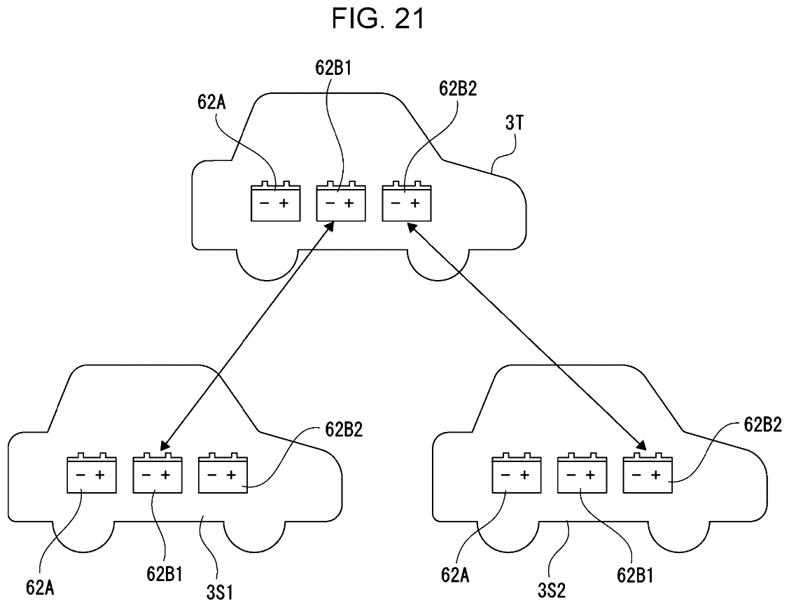

FIG. 21 illustrates the exchange of batteries between the disabled vehicle 3T and each of the rescue vehicles 3S1 and 3S2 at the first meeting point MP1.

As illustrated in FIG. 21, the second battery 62B1 among the second batteries 62B of the disabled vehicle 3T is exchanged with the second battery 62B1 of the rescue vehicle 3S1.

Further, the second battery 62B2 among the second batteries 62B of the disabled vehicle 3T is exchanged with the second battery 62B2 of the rescue vehicle 3S2.

The second batteries 62B1 and 62B2 can be exchanged when the second batteries 62B1 and 62B2 are based on the same standard.

As a result, the disabled vehicle 3T can be replenished with a larger amount of charge to ensure a greater remaining charge at the first meeting point MP1.

In the illustrated example, two rescue vehicles 3S are used. Three or more rescue vehicles 3S may be used.

For example, in a case where four rescue vehicles 3S jointly rescue the disabled vehicle 3T, the disabled vehicle 3T and two of the rescue vehicles 3S may meet at the first meeting point MP1, and the disabled vehicle 3T and the other two rescue vehicles 3S may meet at the second meeting point MP2.

Thus, even when the current position and the destination DP of the disabled vehicle 3T are far from each other, the disabled vehicle 3T can be rescued. In addition, even when the current position and the destination DP of the disabled vehicle 3T are close to each other, a large number of rescue vehicles 3S jointly rescue the disabled vehicle 3T, thereby resulting in a reduction in the secured remaining charge for each rescue vehicle 3S. As a result, the burden on each of the rescue vehicles 3S can be reduced.

### 5-2. Second Modification

In a second modification, as in the first modification, rescue vehicles 3S meet the disabled vehicle 3T at the first meeting point MPl. The difference from the first modification is how the second batteries 62B are exchanged.

The second modification will be described with reference to the accompanying drawings.

A vehicle 3 according to the present modification may include one second battery 62B, as illustrated in FIG. 3.

At the first meeting point MP1, the second battery 62B of each of the disabled vehicle 3T and the two rescue vehicles 3S1 and 3S2 is exchanged with the second battery 62B of another of the disabled vehicle 3T and the two rescue vehicles 3S1 and 3S2. In the following description, in one example, the second battery 62B of the disabled vehicle 3T is referred to as a second battery 62Bt, the second battery 62B of the rescue vehicle 3S1 is referred to as a second battery 62Bs1, and the second battery 62B of the rescue vehicle 3S2 is referred to as a second battery 62Bs2.

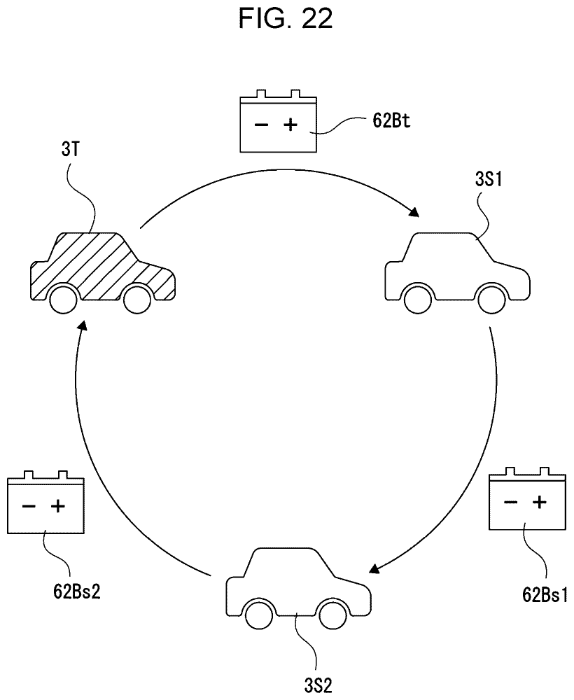

For example, as illustrated in FIG. 22, the second battery 62Bt of the disabled vehicle 3T is passed to the rescue vehicle 3S1. The second battery 62Bs1 of the rescue vehicle 3S1 is passed to the rescue vehicle 3S2. Finally, the second battery 62Bs2 of the rescue vehicle 3S2 is passed to the disabled vehicle 3T.

Such an exchange is suitable for the following conditions, as an example.

For example, a case where the insufficient charge of the disabled vehicle 3T is “100” will be described as an example. As described above, no mention is given to the units for the insufficient charge, which is “100”.

In the rescue vehicle 3S1, the remaining charge of the second battery 62Bs1 can be increased up to “50” by the time when the first meeting point MP1 is reached. However, all of the remaining charge stored in the second battery 62Bs1 can be supplied to the disabled vehicle 3T.

In the rescue vehicle 3S2, the remaining charge of the second battery 62Bs2 can be increased to “100” by the time when the first meeting point MP1 is reached. However, it is difficult to supply all of the remaining charge of the second battery 62Bs2 to the disabled vehicle 3T due to the destination of the rescue vehicle 3S2 and the charging stations present on the route to the destination. Here, it is assumed that “50” of the remaining charge, namely, “100”, stored in the second battery 62Bs2 can be supplied for the disabled vehicle 3T.

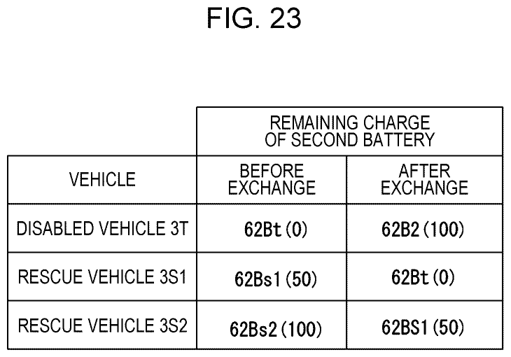

At this time, the exchange of second batteries 62B as described above results in a change in the remaining charge of the second batteries 62B of the vehicles 3, as illustrated in FIG. 23. In FIG. 23, a numerical value in parentheses is a remaining battery charge.

In the disabled vehicle 3T, the remaining charge of the second battery 62B can be “100”.

In the rescue vehicle 3S1, since all of the remaining charge stored in the second battery 62B has been supplied, the remaining charge becomes “0”.

In the rescue vehicle 3S2, “50” of the remaining charge, namely, “100”, stored in the second battery 62B has been supplied through the exchange.

As a result, the second batteries 62B can be appropriately exchanged in consideration of the statuses of the respective vehicles 3.

In the present modification, as an example, the second batteries 62B of three vehicles 3 including the disabled vehicle 3T are exchanged. In another example, the second batteries 62B of four or more vehicles 3 may be exchanged. In this case, two or more disabled vehicles 3T may be included.

### 5-3. Third Modification

In a third modification, the configuration of the first embodiment and the configuration of the second embodiment are selectively used depending on the situation.

For example, when the problem information DT is received from the disabled vehicle 3T, first, the server apparatus 2A or the server apparatus 2B performs the process illustrated in the first embodiment, assuming that one rescue vehicle 3S is responsible for rescuing the disabled vehicle 3T. Accordingly, when one rescue vehicle 3S is determined, the server apparatus 2A or the server apparatus 2B notifies the rescue vehicle 3S of its determination and waits for receiving the rescue result information DR.

On the other hand, if the determination of one rescue vehicle 3S has failed, the server apparatus 2A or the server apparatus 2B determines that rescue vehicles 3S are responsible for rescuing the disabled vehicle 3T, and performs the process illustrated in the second embodiment.

Accordingly, an appropriate number of rescue vehicles 3S are selected according to the status of the disabled vehicle 3T and other statuses such as the statuses of the candidate rescue vehicles 3P to rescue the disabled vehicle 3T.

As another example of the third modification, the configuration of the first embodiment and the configuration of the second embodiment may be implemented at the same time.

For example, a candidate rescue vehicle 3P that attempts to independently rescue the disabled vehicle 3T and a joint rescue candidate group 4 including the candidate rescue vehicles 3P1 and 3P2 that attempt to jointly rescue the disabled vehicle 3T may be simultaneously extracted as vehicles 3 responsible for rescuing the disabled vehicle 3T.

### 5-4. Other Modifications

Other modifications will be described.

As in the first modification and the second modification, rescue vehicles 3S meet the disabled vehicle 3T at the first meeting point MP1.

At the first meeting point MP1, for example, the second battery 62B installed in one of the two rescue vehicles 3S1 and 3S2 is installed in the disabled vehicle 3T through exchange, and the second battery 62B installed in the other rescue vehicle is loaded onto the trunk, roof, or the like of the disabled vehicle 3T.

In the disabled vehicle 3T, the second battery 62B used to travel is appropriately exchanged with the second battery 62B stored in the trunk or the like on the route to the destination. As a result, the disabled vehicle 3T continues traveling to the destination.

This configuration also enables the disabled vehicle 3T to be supplied with the remaining charge necessary to reach the destination.

Further, the meeting point at which the disabled vehicle 3T and the rescue vehicle 3S meet may be set at the current position of the disabled vehicle 3T or at a predetermined position within a range in which the disabled vehicle 3T can travel using the remaining charge.

For example, setting the meeting point at a point different from the current position of the disabled vehicle 3T and closer to the destination of the disabled vehicle 3T can reduce the waiting time of the disabled vehicle 3T and the rescue vehicle 3S, and smooth rescue can be carried out.

That is, the disabled vehicle 3T transmits the problem information DT to the server apparatus 2A or the server apparatus 2B before coming to a complete stop due to running out of electricity, thereby achieving the effects described above.

The rescue request information DA transmitted from the server apparatus 2A or the server apparatus 2B to each of the vehicles 3 is presented to the user. As a result, a result of acceptance or rejection can be obtained from the user.

The rescue request information DA may be presented by using a registered terminal of the user instead of using the display 66 of the vehicle 3.

The presentation of the rescue request information DA using the terminal of the user may be performed by transferring the rescue request information DA from the vehicle 3 to the terminal of the user or by transmitting the rescue request information DA from the server apparatus 2A directly to the terminal of the user.

The second embodiment describes an example in which candidate rescue vehicles 3P responsible for jointly rescuing the disabled vehicle 3T are selected as a joint rescue candidate group 4. In addition, the secured remaining charge is determined before the selection of candidate rescue vehicles 3P belonging to the joint rescue candidate group 4.

Alternatively, after the selection of candidate rescue vehicles 3P belonging to the joint rescue candidate group 4, the secured remaining charge may be determined for each of the candidate rescue vehicles 3P belonging to each joint rescue candidate group 4. That is, after the determination of candidate rescue vehicles 3P belonging to the joint rescue candidate group 4, the secured remaining charge to be allocated to each of the candidate rescue vehicles 3P may be determined.

### 6. First Summary

As described in the first embodiment, the modifications, and the like, a vehicle 3 according to an embodiment of the disclosure includes a traveling battery 62 charged with electric power for the vehicle 3 to travel; one or more processors (processors included in the control device 61); and a storage medium (ROM or RAM of the control device 61 or any other storage area) storing a program to be executed by the one or more processors. The traveling battery 62 includes a first battery 62A and a second battery 62B (62B1, 62B2, 62Bs1, 62Bs2). The program includes one or more instructions. The one or more instructions cause the one or more processors to execute a process (step S403) of receiving rescue request information DA that is information on a request for rescuing a disabled vehicle 3T having an insufficient remaining battery charge, the rescue request information DA including position information of the disabled vehicle 3T and information on an insufficient charge of a battery of the disabled vehicle 3T; a process (step S304) of charging the second battery 62B (62B1, 62B2, 62Bs1, 62Bs2) from the first battery 62A such that the second battery 62B (62B1, 62B2, 62Bs1, 62Bs2) has a remaining charge greater than or equal to the insufficient charge by a time when the vehicle 3 reaches a position indicated by the position information; and a process (step S439) of decreasing, for the first battery 62A, a remaining charge per unit time consumed for travel during charging from the first battery 62A to the second battery 62B (62B1, 62B2, 62Bs1, 62Bs2) compared to during non-charging from the first battery 62A to the second battery 62B (62B1, 62B2, 62Bs1, 62Bs2).

The second batteries 62B (62B1, 62B2, 62Bs1, 62Bs2, 62Bt) are exchanged between the disabled vehicle 3T and a rescue vehicle 3S (3S1, 3S2) selected from among the candidate rescue vehicles 3P (3P1, 3P2, 3P3, 3P4). As a result, the disabled vehicle 3T can resume traveling.

At this time, vehicles 3 other than the disabled vehicle 3T are extracted as candidate rescue vehicles 3P (3P1, 3P2, 3P3, 3P4) when, in each of the vehicles 3, the second battery 62B (62B1, 62B2, 62Bs1, 62Bs2) can secure a remaining charge greater than or equal to the insufficient charge by using the remaining charge of the first battery 62A by the time when the vehicle 3 reaches the meeting point, even if the remaining charge of the second battery 62B (62B1, 62B2, 62Bs1, 62Bs2) is low at the time point when the rescue request information DA is received. In the vehicle 3, furthermore, a process of decreasing the remaining charge consumed for travel and giving priority to a rapid charge to the second battery 62B (62B1, 62B2, 62Bs1, 62Bs2) is performed. Thus, a remaining charge greater than or equal to the insufficient charge can be easily secured by the second battery 62B (62B1, 62B2, 62Bs1, 62Bs2) at the time of meeting the disabled vehicle 3T, and the vehicle 3 is likely to be extracted as a candidate rescue vehicle 3P (3P1, 3P2, 3P3, 3P4).

Many candidate rescue vehicles 3P (3P1, 3P2, 3P3, 3P4) are extracted from among the vehicles 3 other than the disabled vehicle 3T. Thus, it is likely to implement quick rescue of the disabled vehicle 3T.

In the rescue vehicle 3S (3S1, 3S2), ensuring charging of the second battery 62B (62B1, 62B2, 62Bs1, 62Bs2) during travel to meet the disabled vehicle 3T eliminates control to secure a certain level or more of the remaining charge of the second battery 62B (62B1, 62B2, 62Bs1, 62Bs2) during normal driving irrelevant to rescue, and prevents the driving performance from decreasing. That is, it is possible to improve the convenience of the rescue vehicle 3S (3S1, 3S2) in normal conditions.

Further, securing the remaining charge of the second battery 62B (62B1, 62B2, 62Bs1, 62Bs2) during travel to the meeting point can reduce or eliminate the waiting time until charging is completed after the meeting, resulting in shortening of the time taken for the disabled vehicle 3T to resume traveling. This also makes it possible to shorten the time taken for the rescue vehicle 3S (3S1, 3S2) to engage in the rescue, thus minimizing the influence on the time when the rescue vehicle 3S (3S1, 3S2) reaches the destination.

In addition, in a case where a price is to be paid to the rescue vehicle 3S (3S1, 3S2) for the rescue of the disabled vehicle 3T, the rescue of the disabled vehicle 3T can be quickly carried out, thus increasing the number of rescues per unit time, resulting in an increase in revenue.

An increasing number of vehicles 3 perform charging control to finish charging the second battery 62B (62B1, 62B2, 62Bs1, 62Bs2) used for exchange while traveling to the rescue site, thereby providing the drivers of the vehicles 3 with safety even during travel in an area where no charging station or the like is available nearby.

As described above, in the vehicle 3 according to an embodiment of the disclosure, the one or more instructions may cause the one or more processors (processors included in the control device 61) to execute the above-described decreasing process (step S434, step S436, step S439) when a distance from the position of the vehicle 3 to the meeting point to meet the disabled vehicle 3T is shorter than a predetermined distance.

That is, in a case where a remaining charge greater than or equal to the insufficient charge is not secured through normal charging control during travel to the rescue site, a rapid charge is performed at the sacrifice of driving performance. This enables exchange between the second batteries 62B (62B1, 62B2, 62Bs1, 62Bs2, 62Bt) at the time point when the rescue vehicle 3S (3S1, 3S2) reaches the meeting point, and prevents the waiting time from occurring for charging.

In a case where a remaining charge greater than or equal to the insufficient charge is secured through normal charging control during travel to the rescue site, a charge is performed without the sacrifice of driving performance such as acceleration performance. This makes it possible to avoid delays in reaching the meeting point while enhancing the safety of the rescue vehicle 3S (3S1, 3S2) during travel to the rescue site.

In the vehicle 3 according to an embodiment of the disclosure, the one or more instructions may cause the one or more processors (processors included in the control device 61) to execute a process (step S438) of determining whether the vehicle 3 is under a specific condition, and a process (step S440) of avoiding the above-described decreasing process (step S439) when it is determined that the vehicle 3 is under the specific condition.

For example, in some situations, it may be inappropriate to perform a rapid charge while decreasing driving performance. This configuration enabling flexible setting of the specific condition, thus making it possible to restrict cases of performing a rapid charge while decreasing driving performance. Flexible operation is achieved.

In the vehicle 3 according to an embodiment of the disclosure, the one or more instructions may cause the one or more processors (processors included in the control device 61) to execute a process (step S438) of determining that the vehicle 3 is under the specific condition when it is determined that the vehicle 3 is traveling on a road on which vehicles are required or recommended to travel at a predetermined speed or higher.

A decrease in power consumption per unit time in a battery used for the vehicle 3 to travel results in a degradation in acceleration performance, for example. The degradation in acceleration performance is not desirable when, for example, the vehicle 3 is traveling on an expressway.

This configuration prevents a rapid charge from being performed at the sacrifice of driving performance when the vehicle 3 is traveling on a road on which vehicles are required or recommended to travel at a predetermined speed or higher.

Therefore, the safety of the vehicle 3 can be guaranteed.

A rescue system 1A (1B) according to an embodiment of the disclosure is a system including a server apparatus 2A (2B) and vehicles 3. Each of the vehicles 3 includes a first battery 62A and a second battery 62B (62B1, 62B2, 62Bs1, 62Bs2, 62Bt) as a traveling battery 62 charged with electric power for the vehicle 3 to travel.

The server apparatus 2A (2B) includes one or more first processors (CPU 31) and a first storage medium (ROM 32, RAM 33, storage 38) storing a first program to be executed by the one or more first processors (CPU 31). The first program includes one or more first instructions. The one or more first instructions cause the one or more first processors (CPU 31) to execute a process (step S122, step S126) of receiving problem information DT that is information on a request for rescuing a disabled vehicle 3T that is a vehicle 3 having an insufficient remaining battery charge, the problem information DT including position information of the disabled vehicle 3T and information on an insufficient charge of a battery of the disabled vehicle 3T; a process (step S102) of extracting, as a candidate rescue vehicle 3P (3P1, 3P2, 3P3, 3P4), a vehicle 3 that is capable of rescuing the disabled vehicle 3T and in which the second battery 62B (62B1, 62B2, 62Bs1, 62Bs2) is charged from the first battery 62A to ensure that the second battery 62B (62B1, 62B2, 62Bs1, 62Bs2) has a remaining charge greater than or equal to the insufficient charge by a time when the vehicle 3 reaches a position (the current position of the disabled vehicle 3T or the meeting point) indicated by the position information; and a process (step S103) of transmitting rescue request information DA for requesting the candidate rescue vehicle 3P (3P1, 3P2, 3P3, 3P4) to rescue the disabled vehicle 3T.

Further, each of the vehicles 3 includes one or more second processors (processors included in the control device 61) and a second storage medium (ROM or RAM of the control device 61 or any other storage area) storing a second program to be executed by the one or more second processors (processors included in the control device 61). The second program includes one or more second instructions. The one or more second instructions cause the one or more second processors (processors included in the control device 61) to execute a process (step S403) of receiving the rescue request information DA based on the problem information DT; a process of charging the second battery 62B (62B1, 62B2, 62Bs1, 62Bs2) from the first battery 62A such that the second battery 62B (62B1, 62B2, 62Bs1, 62Bs2) has a remaining charge greater than or equal to the insufficient charge by a time when the vehicle 3 reaches the position (the current position of the disabled vehicle 3T or the meeting point); and a process of decreasing, for the first battery 62A, a remaining charge per unit time consumed for travel during charging from the first battery 62A to the second battery 62B (62B1, 62B2, 62Bs1, 62Bs2) compared to during non-charging from the first battery 62A to the second battery 62B (62B1, 62B2, 62Bs1, 62Bs2).

The rescue system 1A (1B) can achieve the various operations and effects described above.

### 7. Second Summary

As described in the second embodiment, the modifications, and the like, a server apparatus 2B according to an embodiment of the disclosure includes one or more processors (CPU 31) and a storage medium (ROM 32, RAM 33, storage 38) storing a program to be executed by the one or more processors (CPU 31). The program includes one or more instructions. The one or more instructions cause the one or more processors (CPU 31) to execute a process of receiving problem information DT from a disabled vehicle 3T having an insufficient remaining battery charge, the problem information DT including position information of the disabled vehicle 3T and charge insufficiency information of a battery of the disabled vehicle 3T; a process (step S102) of extracting candidate rescue vehicles 3P (3P1, 3P2, 3P3, 3P4) that are vehicles 3 other than the disabled vehicle 3T, each of the candidate rescue vehicles 3P (3P1, 3P2, 3P3, 3P4) being capable of rescuing the disabled vehicle 3T and including a first battery 62A and a second battery 62B (62B1, 62B2, 62Bs1, 62Bs2); a process (step S135) of selecting, as a joint rescue candidate group 4 (first group 4X, second group 4Y), two or more candidate rescue vehicles 3P (3P1, 3P2, 3P3, 3P4) from among the candidate rescue vehicles 3P (3P1, 3P2, 3P3, 3P4) to jointly rescue the disabled vehicle 3T; a process (step S102, step S135) of determining, based on the charge insufficiency information, a secured remaining charge that is a remaining charge to be secured by the second battery 62B (62B1, 62B2, 62Bs1, 62Bs2) of each of the candidate rescue vehicles 3P (3P1, 3P2, 3P3, 3P4) in the joint rescue candidate group 4 (first group 4X, second group 4Y); and a process (step S103) of notifying each of the candidate rescue vehicles 3P (3P1, 3P2, 3P3, 3P4) in the joint rescue candidate group 4 (first group 4X, second group 4Y) of the secured remaining charge to charge the second battery 62B (62B1, 62B2, 62Bs1, 62Bs2) from the first battery 62A such that the second battery 62B (62B1, 62B2, 62Bs1, 62Bs2) has a remaining charge greater than or equal to the secured remaining charge.

In some situations, even when second batteries 62B (62B1, 62B2, 62Bs1, 62Bs2, 62Bt) are exchanged between one rescue vehicle 3S (3S1, 3S2) and the disabled vehicle 3T, it may be difficult for the disabled vehicle 3T to reach a destination such as a charging station.

This configuration enables the rescue vehicles 3S (3S1, 3S2) to be selected to rescue the disabled vehicle 3T.

Accordingly, two or more batteries exchangeable with the second battery 62B (62Bt) of the disabled vehicle 3T can be prepared, and the distance that can be traveled by the disabled vehicle 3T can be increased.

This makes it more likely that the disabled vehicle 3T can travel to the destination such as a charging station and address the problem.

When the distance from the current position of the disabled vehicle 3T to a charging station available is long, the problem can be addressed by selecting three or more rescue vehicles 3S (3S1, 3S2). In other words, this configuration makes it more likely that even the disabled vehicle 3T whose distance to the charging station is long can be rescued, and can improve convenience.

In the server apparatus 2B, the one or more instructions may cause the one or more processors (CPU 31) to execute a process (step S131) of calculating information on a meeting point at which each of the candidate rescue vehicles 3P (3P1, 3P2, 3P3, 3P4) in the joint rescue candidate group 4 (first group 4X, second group 4Y) meets the disabled vehicle 3T; and a process (step S103) of notifying each of the candidate rescue vehicles 3P (3P1, 3P2, 3P3, 3P4) in the joint rescue candidate group 4 (first group 4X, second group 4Y) of the meeting point.

This clarifies the meeting point to meet the disabled vehicle 3T and the travel distance to the meeting point. Thus, in the rescue vehicle 3S (3S1, 3S2), efficient charging control of the second battery 62B (62B1, 62B2, 62Bs1, 62Bs2) can be implemented.

In the server apparatus 2B, the meeting point may be different for each of the candidate rescue vehicles 3P (3P1, 3P2, 3P3, 3P4) in the joint rescue candidate group 4 (first group 4X, second group 4Y).

For example, the disabled vehicle 3T travels to a destination such as a charging station through a via point. In this case, the second battery 62Bt of the disabled vehicle 3T is exchanged with the second battery 62Bs1 of the first rescue vehicle 3S1 at the current position of the disabled vehicle 3T, thereby enabling the disabled vehicle 3T to travel to the via point. At the via point, the second battery 62Bs1 is further exchanged with the second battery 62Bs2 of the second rescue vehicle 3S2, thereby enabling the disabled vehicle 3T to travel from the via point to the destination.

Accordingly, when the second rescue vehicle 3S2 is closer to the via point than the current position of the disabled vehicle 3T, the travel distance of the second rescue vehicle 3S2 can be shortened. The burden on the driver of the second rescue vehicle 3S2 can be reduced.

In the server apparatus 2B, the secured remaining charge may be an amount of electric power chargeable from the first battery 62A to the second battery 62B (62B1, 62B2, 62Bs1, 62Bs2) during travel by a time when each of the candidate rescue vehicles 3P (3P1, 3P2, 3P3, 3P4) reaches the meeting point.

For example, the first rescue vehicle 3S1 is charged with electric power that can be secured without difficulty during travel to a first meeting point MP1 (MP1′) to meet the disabled vehicle 3T. The disabled vehicle 3T meets the second rescue vehicle 3S2 at a second meeting point MP2 (MP2′) set at a distance to which the disabled vehicle 3T can travel using the second battery 62Bs1 obtained through the exchange. The second rescue vehicle 3S2 is charged with electric power that can be secured without difficulty during travel to the second meeting point MP2 (MP2′), and the second battery 62Bs2 of the second rescue vehicle 3S2 is exchanged with the second battery (the second battery 62Bs1 exchanged with the second battery 62Bt) of the disabled vehicle 3T at the second meeting point MP2 (MP2′).

Repeating the operations described above allows the disabled vehicle 3T to travel to the destination such as a charging station, and prevents each rescue vehicle 3S (3S1, 3S2) from performing a rapid charge at the sacrifice of driving performance.

This provides the driver of the disabled vehicle 3T with safety such as traveling to the charging station. In addition, a rapid charge at the sacrifice of driving performance is not performed, which ensures that the driver of the rescue vehicle 3S (3S1, 3S2) does not feel uncomfortable when operating the vehicle 3 during driving, thereby increasing safety during travel.

As described in the second embodiment, the modifications, and the like, a vehicle 3 according to an embodiment of the disclosure includes a traveling battery 62 charged with electric power for the vehicle 3 to travel, one or more processors (processors included in the control device 61), and a storage medium (ROM or RAM of the control device 61 or any other storage area) storing a program to be executed by the one or more processors (processors included in the control device 61). The traveling battery 62 includes a first battery 62A and a second battery 62B (62B1, 62B2, 62Bs1, 62Bs2). The program includes one or more instructions. The one or more instructions cause the one or more processors (processors included in the control device 61) to execute a process (step S403) of receiving rescue request information DA that is information on a request for rescuing a disabled vehicle 3T having an insufficient remaining battery charge, the rescue request information DA including information on a meeting point at which the vehicle 3 meets the disabled vehicle 3T and information on a secured remaining charge, the secured remaining charge being an amount of electric power to be secured by the vehicle 3 to compensate for the insufficient remaining battery charge of the disabled vehicle 3T in cooperation with another vehicle 3; and a process of charging the second battery 62B (62B1, 62B2, 62Bs1, 62Bs2) from the first battery 62A such that the second battery 62B (62B1, 62B2, 62Bs1, 62Bs2) has a remaining charge greater than or equal to the secured remaining charge by a time when the vehicle 3 reaches the meeting point.

The vehicle 3 can achieve the various operations and effects described above.

The embodiments, modifications, and the like described above may be combined as appropriate.

In some situations, even when second batteries are exchanged between one candidate rescue vehicle and a disabled vehicle, it may be difficult for the disabled vehicle to reach a destination such as a charging station.

The configuration described above enables selection of rescue vehicles to rescue a disabled vehicle.

According to an embodiment of the disclosure, it is possible to efficiently rescue a disabled vehicle that has encountered a problem related to running out of electricity.

The CPU 31 illustrated in FIG. 4 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the CPU 31 including the vehicle information registration processor F1, the problem information reception processor F2, the candidate rescue vehicle extraction processor F3, the vehicle information acquisition processor F4, the rescue request information transmission processor F5, the rescue vehicle determination processor F6, the fee calculation processor F7, the payment processor F8, and the battery delivery management processor F9. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 4.

The control device 61 illustrated in FIG. 5 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control device 61 including the vehicle information transmitter F31, the problem information transmitter F32, the rescue request information receiver F33, the acceptance result transmitter F34, the rapid charge feasibility determiner F35, and the rapid charge executer F36. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 5.

1. A server apparatus comprising:
one or more processors; and
a storage medium storing a program configured to be executed by the one or more processors, wherein
the program comprises one or more instructions, and
the one or more instructions are configured to cause the one or more processors to:
receive problem information from a disabled vehicle having an insufficient remaining battery charge, the problem information comprising position information of the disabled vehicle and charge insufficiency information of a battery of the disabled vehicle;
extract a plurality of candidate rescue vehicles that are vehicles other than the disabled vehicle, each of the candidate rescue vehicles being configured to rescue the disabled vehicle and comprising a first battery and a second battery;
select, as a joint rescue candidate group, two or more candidate rescue vehicles from among the candidate rescue vehicles to jointly rescue the disabled vehicle;
determine, based on the charge insufficiency information, a secured remaining charge that is a remaining charge to be secured by the second battery of each of the two or more candidate rescue vehicles in the joint rescue candidate group; and
notify each of the two or more candidate rescue vehicles in the joint rescue candidate group of the secured remaining charge to charge the second battery from the first battery such that the second battery has a remaining charge greater than or equal to the secured remaining charge.

2. The server apparatus according to claim 1, wherein the one or more instructions are configured to further cause the one or more processors to:
calculate information on a meeting point at which each of the two or more candidate rescue vehicles in the joint rescue candidate group meets the disabled vehicle; and
notify each of the two or more candidate rescue vehicles in the joint rescue candidate group of the meeting point.

3. The server apparatus according to claim 2, wherein the meeting point is different for each of the two or more candidate rescue vehicles in the joint rescue candidate group.

4. The server apparatus according to claim 2, wherein the secured remaining charge is an amount of electric power chargeable from the first battery to the second battery during travel by a time when each of the two or more candidate rescue vehicles in the joint rescue candidate group reaches the meeting point.

5. A vehicle comprising:
a traveling battery charged with electric power for the vehicle to travel;
one or more processors; and
a storage medium storing a program configured to be executed by the one or more processors, wherein
the traveling battery comprises a first battery and a second battery,
the program comprises one or more instructions, and
the one or more instructions are configured to cause the one or more processors to:
receive rescue request information that is information on a request for rescuing a disabled vehicle having an insufficient remaining battery charge, the rescue request information comprising information on a meeting point at which the vehicle meets the disabled vehicle and information on a secured remaining charge, the secured remaining charge being an amount of electric power to be secured by the vehicle to compensate for the insufficient remaining battery charge of the disabled vehicle in cooperation with another vehicle; and
charge the second battery from the first battery such that the second battery has a remaining charge greater than or equal to the secured remaining charge by a time when the vehicle reaches the meeting point.
